(19) United States
(12) Patent Application Publication
(10) Pub. No.: US 2026/0289107 A1
(43) Pub. Date: Sep. 24, 2026

(54) SYSTEM

(71) Applicant: SoftBank Group Corp., Tokyo (JP)

(72) Inventor: Masahiko SATO, Tokyo (JP)

(73) Assignee: SoftBank Group Corp., Tokyo (JP)

(21) Appl. No.: 19/565,528

(22) Filed: Mar. 13, 2026

(30) Foreign Application Priority Data
Mar. 19, 2025 (JP) 2025-045023

(51) Int. Cl. G06F 40/20; G10L 15/26; G10L 25/66

(52) U.S. Cl. CPC G06F 40/20; G10L 15/26; G10L 25/66

(57) ABSTRACT

A system includes a processor that is configured to process voice data by using a speech recognition unit that converts a voice input into text data, generate a prompt sentence for input to a generative AI model, and analyze the text data by using the generative AI model to identify a risk pattern.

### CROSS-REFERENCE TO RELATED APPLICATION

This application is based on and claims priority under 35 USC 119 from Japanese Patent Application No. 2025-045023 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional cognitive assessment and dementia risk evaluation techniques largely rely on periodic clinical examinations, standardized questionnaires, or manually administered interviews by specialists. Such approaches are labor-intensive, time-consuming, and difficult to apply continuously in daily life, which can delay the detection of subtle early-stage symptoms. Further, existing automated systems that analyze voice or text data are often rule-based or use simple statistical models, and therefore have limited capability to capture complex linguistic and behavioral patterns that may indicate dementia risk. In addition, there is insufficient integration between conversational analysis, lifestyle and health data, and user guidance, such that users are not promptly informed of their risk level nor appropriately encouraged to consult medical institutions when necessary. Accordingly, there is a need for a system that can automatically convert user voice input into text data, generate suitable prompts for a generative AI model, analyze the text data and other user data to identify dementia-related risk patterns with high precision, and provide timely feedback and recommendations to the user.

### SUMMARY

In order to solve the above-described problems, the present invention provides a system comprising a processor, wherein the processor is configured to process voice data by using a speech recognition unit that converts a voice input into text data, generate a prompt sentence for input to a generative AI model, and analyze the text data by using the generative AI model to identify a risk pattern. The processor is further configured to notify a user of an analysis result, and to generate an instruction that prompts the user to consult a medical institution when necessary. In addition, the processor is configured to collect behavior data and health data of a user, generate a prompt for instructing the generative AI model to evaluate a dementia risk based on the behavior data and the health data, and input the prompt to the generative AI model to evaluate the dementia risk. Through these configurations, the system enables continuous and automated extraction of dementia-related risk patterns from natural voice or text interactions and lifestyle data, and provides appropriate guidance to the user for prevention, early detection, and timely consultation with a medical institution.

The term “system” refers to an arrangement comprising at least one processor and, optionally, one or more memories, input/output interfaces, communication interfaces, sensors, or other hardware and software components configured to perform the processing described in the claims.

The term “processor” refers to any hardware component or combination of hardware components capable of executing instructions, including, but not limited to, a central processing unit (CPU), a graphics processing unit (GPU), a digital signal processor (DSP), an application specific integrated circuit (ASIC), a field programmable gate array (FPGA), or a microcontroller.

The term “voice data” refers to electronic data representing an acoustic signal generated by spoken utterances of a user, including raw audio waveforms, digitized audio samples, or encoded audio streams.

The term “voice input” refers to spoken utterances provided by a user to the system through a microphone or other audio capture device, which are to be processed as voice data.

The term “speech recognition unit” refers to a hardware component, a software component, or a combination thereof, configured to receive voice data and convert the voice data into corresponding text data by recognizing spoken words and phrases.

The term “text data” refers to data representing characters, words, sentences, or other textual information obtained by converting voice data or directly input by a user, and used as input to the generative AI model or for subsequent analysis.

The term “prompt sentence” refers to a text string or structured textual content that is generated by the processor and provided as input to the generative AI model in order to specify an analysis task, a context, or instructions for processing the text data or other user data.

The term “generative AI model” refers to a machine learning model, such as a large language model or other neural network-based model, that is capable of generating or analyzing text data based on an input prompt and is used to identify, infer, or evaluate patterns related to dementia risk.

The term “risk pattern” refers to a pattern or combination of features detected in the text data, behavior data, or health data that is indicative of a potential risk, tendency, or likelihood related to dementia or cognitive decline.

The term “analysis result” refers to information output by the processor based on processing performed using the generative AI model, including identified risk patterns, evaluated dementia risk levels, or summary metrics derived from the text data, behavior data, or health data.

The term “behavior data” refers to data representing user actions or habits in daily life, including, but not limited to, activity levels, exercise records, sleep patterns, device usage logs, or other measurable behavioral indicators.

The term “health data” refers to data related to the physical or mental health status of a user, including, but not limited to, medical history, biometric measurements, test results, medication information, or self-reported health conditions.

The term “dementia risk” refers to an estimated likelihood, probability, or level of concern that a user may currently exhibit, or in the future develop, symptoms associated with dementia or cognitive impairment, as evaluated by the generative AI model based on the available data.

The term “medical institution” refers to any facility or organization that provides medical services, including, but not limited to, hospitals, clinics, medical centers, or other healthcare providers, and which employs physicians or qualified medical professionals.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

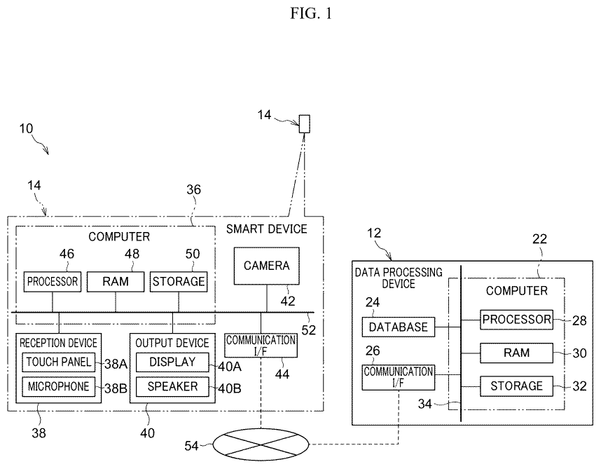

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

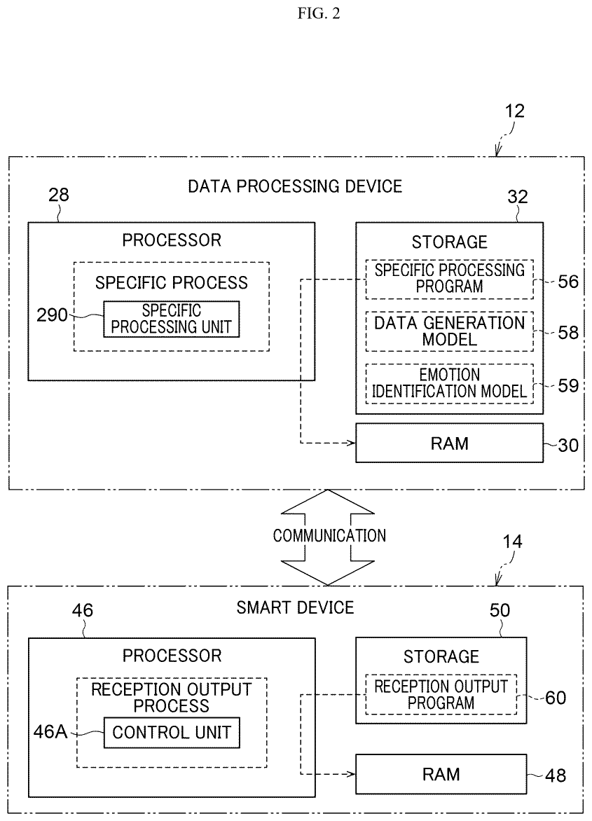

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems for assessing dementia risk from user input suffer from several technical limitations in the way they acquire, structure, and process natural language data. Typical implementations either perform simple keyword matching or apply fixed statistical models directly to raw text, without dynamically controlling the behavior of a generative AI model by means of a structured prompt sentence. As a result, the processing pipeline within the computer system is inefficient, inflexible, and often produces unstructured or non-actionable outputs that are difficult to store, track over time, or present in a consistent format on heterogeneous client devices.

In particular, existing systems do not adequately integrate multiple heterogeneous data types, such as voice input, character input, behavioral information, and biological information, into a unified machine-readable representation prior to analysis. Voice input is often converted to text as a mere transcription step, without incorporating user-related information, time-series information, or additional context into a combined input data structure for the generative AI model. This leads to suboptimal utilization of computing resources, because the model must infer context that the system could have explicitly provided, and the server cannot easily standardize output formats or maintain consistent longitudinal records in storage devices.

Furthermore, known systems do not provide technical mechanisms on the server side to (i) automatically generate prompt sentences that encode evaluation items, output formats, and summary data, (ii) normalize and classify extracted risk patterns according to internal categories, and (iii) store analysis result data in a time-series manner for each user to generate transition information of risk levels. Without such mechanisms, the server cannot reliably transform unstructured language data into structured analysis result data, which in turn hinders efficient retrieval, trend analysis, and adaptive generation of user-facing output information. This lack of structure at the processing level within the computer system degrades the overall performance, scalability, and reliability of dementia-risk assessment services.

Moreover, many existing solutions focus primarily on the medical interpretation of the results, rather than on improving the underlying computer technology for data processing, communication, and presentation. They do not clearly define, at the system level, how a processor should orchestrate the sequence of operations: acquisition and conversion of input information, construction of generative AI model input data, storage of output in a storage device, and controlled transmission to terminal devices over a communication network. Consequently, these systems fail to provide a robust, reusable, and extensible technical framework that can support continuous monitoring, adaptive prompting, and consistent user interaction across different hardware platforms.

Accordingly, there is a need for an improved computer-implemented system that uses a processor to (a) convert heterogeneous user inputs into standardized character information, (b) construct structured prompt sentences and combined input data for a generative AI model, (c) obtain, classify, and store structured analysis result data including risk patterns and risk levels in a time-series manner, and (d) generate and transmit output information that is machine-structured and suitable for consistent visual or auditory presentation on terminal devices. By addressing these issues at the level of computer architecture and data processing flow, the invention aims to improve the technical functioning of the server and terminal devices involved in dementia-risk assessment.

The specific processing by the specific processing unit 290 of the data processing device 12 in Example 1 is realized by the following means.

The present invention provides a server comprising a processor configured to acquire input information including voice information or character information and convert the voice information into character information, generate, on the basis of the character information and user-related information, a prompt sentence including evaluation items and an output format relating to a risk of cognitive function decline, generate input data by combining the prompt sentence with the character information, input the input data to a generative artificial intelligence model and obtain analysis result data by extracting risk patterns by natural language processing, classifying the risk patterns, and calculating a risk level, store the analysis result data in a storage device in association with time-series information and generate transition information of the risk level for each user, generate output information including an explanatory sentence for the user and action recommendation information on the basis of the analysis result data and the transition information of the risk level, and transmit the output information to a terminal device via a communication network. This enables a computer-implemented processing pipeline in which heterogeneous user inputs are normalized into character information, dynamically structured prompt sentences and combined input data are supplied to a generative AI model under explicit control of the processor, model outputs are transformed into structured, time-series analysis result data in the storage device, and machine-readable output information is generated and transmitted for consistent visual or auditory presentation on terminal devices, thereby improving the technical performance, scalability, and reliability of dementia-risk assessment operations executed by the server.

The term “processor” refers to a hardware information processing element, such as a central processing unit or a logic circuit, that executes machine-readable instructions to perform operations including data acquisition, data conversion, data analysis, data storage, and data transmission in the system.

The term “input information” refers to information acquired by the system from a user or a device, including at least voice information and character information, and optionally including context information such as user-related information, time information, behavior information, and biological information.

The term “voice information” refers to information representing sound signals of user speech, including raw audio waveforms or encoded audio data capable of being processed by a computer to perform speech recognition.

The term “character information” refers to information expressed as a sequence of characters, symbols, or text strings, including information obtained by converting voice information through speech recognition and information directly input by the user through a character input interface.

The term “user-related information” refers to information associated with a user, including, for example, identification information, demographic information, usage history information, or other attributes used by the processor to generate a prompt sentence or to analyze risk patterns.

The term “prompt sentence” refers to a machine-readable instruction expression, represented in a natural language or structured format, that specifies analysis objectives, evaluation items, output formats, or context to control the behavior of a generative artificial intelligence model.

The term “input data” refers to a data structure generated by the processor by combining the prompt sentence with the character information and, optionally, additional information, and supplied as an input to the generative artificial intelligence model.

The term “generative artificial intelligence model” refers to a machine learning model configured to generate or transform information, which receives the input data including the prompt sentence and character information, performs natural language processing, and outputs analysis result data such as extracted risk patterns and risk levels.

The term “natural language processing” refers to a set of computational techniques by which a computer system interprets, analyzes, or generates human language expressions, including operations such as tokenization, semantic analysis, classification, and pattern extraction applied to character information.

The term “risk pattern” refers to a feature, tendency, or linguistic expression detected from character information that is associated with a risk of cognitive function decline, and that can be categorized and used for risk evaluation.

The term “risk level” refers to an index value or category representing the magnitude or degree of a risk of cognitive function decline for a user, which is calculated by the processor on the basis of detected risk patterns and optionally additional information.

The term “analysis result data” refers to structured data output from the generative artificial intelligence model and post-processed by the processor, including at least risk patterns, classifications of the risk patterns, and a risk level, and optionally including explanation information or confidence values.

The term “storage device” refers to a computer-readable storage medium, such as semiconductor memory, magnetic storage, or optical storage, that stores analysis result data, time-series information, and other data used or generated by the processor.

The term “time-series information” refers to information indicating temporal relationships, including timestamps or ordering data, that enable association of analysis result data with respective points in time or with chronological sequences of user inputs.

The term “transition information of the risk level” refers to information derived from multiple instances of risk level values stored in association with time-series information, representing changes or trends of the risk level for each user over time.

The term “output information” refers to information generated by the processor for presentation to a user via a terminal device, including at least an explanatory sentence and action recommendation information, and optionally including risk patterns, risk levels, and transition information of the risk level.

The term “explanatory sentence” refers to a text expression generated by the processor that describes, in a human-readable form, the meaning of the analysis result data, including the detected risk patterns and the risk level.

The term “action recommendation information” refers to information that suggests actions to be taken by a user, such as consulting a specialized institution, changing lifestyle habits, or performing monitoring, based on the analysis result data and the risk level.

The term “terminal device” refers to an information processing apparatus, such as a portable terminal, a stationary terminal, or a display device, configured to communicate with the server via a communication network and to present output information visually or audibly to the user.

The term “communication network” refers to a wired or wireless data communication infrastructure, such as a local area network, a wide area network, or the Internet, that enables data transmission between the server and one or more terminal devices.

The term “specialized institution” refers to an organization or facility that provides professional evaluation, diagnosis, or treatment relating to cognitive function or health, such as a medical facility or a consultation center.

The term “behavior information” refers to information representing actions, activities, or habits of a user, which may be derived from sensor data, application usage logs, or self-reported records and used as part of additional information.

The term “biological information” refers to information relating to a physiological or physical state of a user, such as heart rate, sleep pattern, or other measurable biological parameters, which may be used as part of additional information.

The term “additional information” refers to information other than the character information that is related to the user, including behavior information, biological information, or environmental information, and that is used to supplement the evaluation of risk of cognitive function decline.

The term “additional-information summary data” refers to data generated by the processor by summarizing the additional information into a compressed or abstracted representation suitable for inclusion in the prompt sentence or in the input data for the generative artificial intelligence model.

In one or more embodiments, a server, a terminal, and a user cooperate to implement a system that evaluates a risk of cognitive function decline by using a generative AI model controlled via a structured prompt sentence. The following describes exemplary modes for carrying out the invention. These modes are provided for illustration and are not intended to limit the scope of the claims.

### A. System Configuration

A server includes a processor, a memory, a storage device, a network interface, and optionally a hardware accelerator. The processor is, for example, a multi-core central processing unit. The memory is, for example, a volatile semiconductor memory. The storage device is, for example, a non-volatile semiconductor memory or a magnetic storage device. The network interface is configured to communicate with one or more terminals via a communication network.

A terminal includes a processor, a memory, a display device, an audio input device, a user input device, and a network interface. The audio input device is, for example, a microphone. The display device is, for example, a liquid crystal display or an organic light-emitting diode display. The terminal executes an application program for acquiring user input and for presenting analysis results.

A user operates the terminal to provide voice information or character information relating to the user's daily life, memory status, and other conditions. The user also confirms and reviews analysis results displayed or output by the terminal.

### B. Program Modules and Hardware/Software Components

The server executes multiple program modules stored in the storage device. In one embodiment, the server uses an operating system and a server-side framework. The server further uses a database management system to store analysis result data and time-series information.

The server uses a generative AI model implemented as a neural network model. The generative AI model is stored on a computer-readable storage medium and executed on the processor and, optionally, on a graphical processing unit. The generative AI model is, for example, a transformer-based language model trained on a large text corpus. The model architecture includes a plurality of encoder-decoder layers, self-attention mechanisms, feed-forward neural network sublayers, and normalization layers. The model uses tokenization to convert character information into token sequences and uses positional encodings to capture word order.

The terminal executes an application program. The terminal uses an operating system and a graphical user interface toolkit. The terminal uses an audio subsystem to acquire voice information and uses a speech recognition engine. The speech recognition engine may be executed on the terminal or on the server. When the speech recognition engine is executed on the server, the terminal transmits audio data to the server, and the server returns character information.

### C. Data Structures and Internal Representations

The server uses specific data structures for efficient processing and storage. For example, the server uses a user input record that includes fields for a user identifier, a timestamp, and character information. The server uses an analysis result record that includes fields for risk patterns, categories of the risk patterns, severity values, a risk level, and metadata.

The server uses an internal data structure for a prompt sentence. The prompt sentence structure includes fields for evaluation items, an output format specification, additional-information summary data, and an instruction portion. The processor constructs the prompt sentence as a character string that is interpretable by the generative AI model.

The server uses additional-information summary data that aggregates behavior information and biological information. The processor uses algorithms such as statistical aggregation, binning, or feature extraction to transform raw additional information into a compact representation. For example, the processor computes an average number of daily forgetfulness events over a predefined period, a variance of sleep duration, or a trend in physical activity level.

### D. Generative AI Model Architecture and Training

The server uses a generative AI model configured as a deep neural network. The model includes an embedding layer, a plurality of transformer blocks, and an output projection layer. Each transformer block includes a multi-head self-attention module and a position-wise feed-forward module. The model parameters are stored as numerical weights and bias values in the storage device and loaded into memory for inference.

The server uses a supervised learning algorithm to train the generative AI model. The server, or a training subsystem, minimizes a loss function such as a cross-entropy loss between predicted token distributions and reference tokens. During training, the server performs forward propagation to compute predictions and backpropagation to compute gradients of the loss with respect to model parameters. The server uses an optimization algorithm such as stochastic gradient descent with momentum or adaptive moment estimation to update the weights. The server optionally uses regularization methods such as dropout and weight decay.

The server uses domain-specific training data that includes user-like texts and labels representing risk patterns, categories, and risk levels. The server constructs input sequences that contain concatenated prompt sentences and example texts. The server uses data augmentation techniques, such as paraphrasing and synonym replacement, to increase the variety of training examples and to improve the robustness of pattern detection.

### E. Program Operation in the Server

The server performs specific data processing and data computation to implement the claimed functions.

The server acquires input information from the terminal via the network interface. When the terminal transmits voice information, the server optionally converts the voice information into character information by using a speech recognition engine. The speech recognition engine uses an acoustic model and a language model to produce a text transcription.

The server generates a prompt sentence on the basis of character information and user-related information. The server combines evaluation items, such as extraction of risk patterns and calculation of a risk level, with an output format specification. For example, the server generates the following prompt sentence:
“You are an assistant that analyzes user language to assess dementia-related risk patterns. Analyze the following user text and detect and list all ‘risk patterns’ that may indicate a risk of cognitive function decline. For each pattern, provide (1) a short description, (2) one category from {memory issue, orientation issue, language issue, executive function issue, other}, and (3) a severity score from 1 (very mild) to 5 (very severe). Then estimate the overall risk level as low, medium, or high, and give a brief explanation in plain language that can be shown directly to the user. Respond in a structured format. User text: [character information].”

The server generates input data by concatenating the prompt sentence with the character information and by embedding additional-information summary data when available. For example, the server appends a sentence such as:
“Additional information summary: number of recent forgetfulness events=5 per week; average sleep duration=5.5 hours; activity level=low.”

The server tokenizes the combined input data and converts the tokens into numerical embeddings. The server feeds the embeddings into the generative AI model. The generative AI model processes the embeddings through multiple transformer blocks, applies attention mechanisms to capture dependencies between tokens, and generates output token probabilities sequentially. The server samples or selects the most probable tokens to form an output text that represents analysis result data.

The server post-processes the output text to extract structured fields. The server, for example, applies parsing rules or a lightweight classifier to identify risk patterns, categories, severity values, and a risk level from the output text. The server maps free-form descriptions of risk patterns to internal codes. The server calculates transition information of the risk level by associating the risk level with time-series information and by computing changes over multiple records.

The server stores analysis result data and transition information in the storage device. The server uses indexing structures, such as time-based indexes and user-based indexes, to enable fast retrieval and aggregation. The server uses compression techniques to reduce storage size and to accelerate I/O operations.

The server generates output information for the terminal. The server constructs explanatory sentences that describe detected risk patterns and the risk level in a human-readable form. The server generates action recommendation information. The server also determines whether a risk level exceeds a predetermined threshold and, if so, adds instruction information that prompts consultation with a specialized institution.

The server transmits the output information to the terminal via the communication network by using a communication protocol. The server may also adjust the level of detail in the output information based on the characteristics of the terminal, such as display size or available bandwidth.

### F. Program Operation in the Terminal

The terminal acquires voice information from the user by using the audio input device. The terminal digitizes the voice information and stores it temporarily in memory. The terminal either performs speech recognition locally or transmits the audio data to the server for recognition.

The terminal acquires character information from the user through a text input interface. The terminal displays an input field and receives keyboard input or touch input. The terminal displays the recognized or typed character information and allows the user to confirm or edit the text.

The terminal transmits input information to the server by creating a structured message that includes a user identifier, a timestamp, and character information. The terminal uses encryption and authentication mechanisms to ensure secure communication.

The terminal receives output information from the server and presents the information to the user. The terminal displays the explanatory sentence, the risk level, and the action recommendation information in a graphical user interface. The terminal may also output the information audibly via a speech synthesis engine.

### G. Technical Effects and Improvements

The server improves computer technology in several ways.

The server uses a structured prompt sentence and input data construction process to constrain and guide the generative AI model. By explicitly encoding evaluation items, output formats, and additional-information summary data into the prompt sentence, the server reduces ambiguity in model behavior, reduces the size of post-processing logic, and increases the consistency of output formats. This leads to improved processing speed because the server can parse model outputs deterministically, and it reduces the amount of computational resources needed for error handling.

The server uses time-series storage of analysis result data and transition information of the risk level. By storing normalized risk patterns and levels in structured records indexed by time and user, the server enables efficient retrieval and aggregation operations. This improves data management and allows the server to compute trends without reprocessing historical character information through the model. As a result, the server reduces repeated model inference, which improves computational efficiency and reduces energy consumption.

The server uses a neural network architecture configured for domain-specific pattern detection. The server designs training datasets and loss functions so that the model emphasizes detection of subtle linguistic cues. The server, by training the model with augmented examples and domain labels, achieves higher accuracy than simple rule-based systems or generic keyword searches. The server thereby improves the precision and recall of risk-pattern identification, which is a technical improvement in the model's functioning.

The server uses non-conventional processing sequences that differ from manual human evaluation. For example, the server transforms high-dimensional additional information into summary features and injects these features into the prompt sentence. The server enforces specific output structures by instructing the model to follow a detailed format. This combination of pre-structuring input data and post-structuring output data is not a mere automation of human reasoning but a specialized data pipeline that is optimized for machine execution. This configuration enables the server to operate with reduced latency and fewer errors in large-scale environments with many users and terminals.

The server, by coordinating the generative AI model and the storage device with explicit data structures and prompt sentence control, achieves a technical effect of reducing communication load. Because the server can store and reuse transition information, the server can omit detailed historical character information from responses, sending only compact summaries to terminals. This reduces the size of messages and improves the scalability of the system over networks with limited bandwidth.

### H. Variations and Alternative Embodiments

The server can optionally use different types of generative AI models. For example, the server can use a sequence-to-sequence model or a decoder-only model. The server can adjust hyperparameters such as the number of layers, hidden dimensions, and attention heads according to deployment constraints.

The server can use different speech recognition engines or language models. The server can perform some preprocessing, such as noise reduction or speaker diarization, before speech recognition. The server can also adapt the prompt sentence according to user profiles, languages, or cultural backgrounds.

The terminal can be a portable device or a stationary device. The terminal can perform more or fewer processing functions locally, depending on its computational capacity. For example, a high-performance terminal can execute an on-device generative AI model with a smaller architecture derived from the server model.

The user can provide various forms of behavior information and biological information through sensors, wearable devices, or external services. The server can adapt the additional-information summary generation algorithm accordingly.

By implementing these embodiments, the server, the terminal, and the user collectively realize a system that is technically configured to perform efficient, accurate, and scalable evaluation of risk of cognitive function decline, while improving internal computer operations, storage structures, and communication efficiency beyond a mere automation of human mental processes.

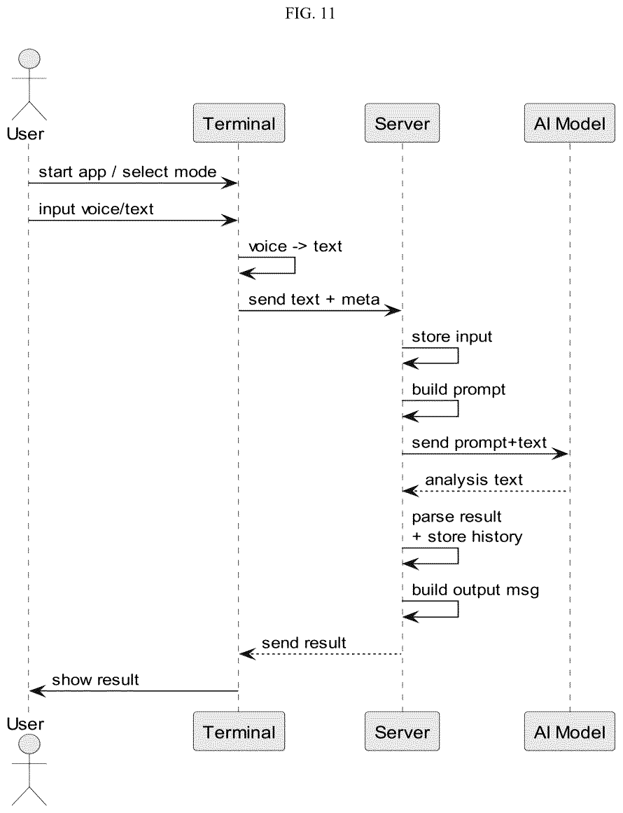

The following describes the processing flow using FIG. 11.

### Step 1:

User operates the terminal to start an application for cognitive risk assessment.

User selects an input mode such as voice input or text input on the terminal screen.

Input: User intention to start an assessment (mode selection event).

Output: Terminal state configured for the selected input mode, including activation of microphone or text input field.

### Step 2:

User provides voice information or character information describing daily conditions, concerns, or memory-related events.

User, in voice mode, speaks a sentence such as “Recently I often forget where I put things and sometimes miss appointments.”

Input: User speech or typed text.

Output: Raw audio data stored in a buffer (for voice mode) or raw character information in a text field (for text mode).

### Step 3:

Terminal acquires and digitizes the user's voice information.

Terminal samples the analog voice signal via the microphone and converts it to digital audio data using an analog-to-digital converter and audio driver.

Input: Analog audio signal from the user's speech.

Output: Digital audio data (for example, linear PCM or compressed audio frames) stored in terminal memory.

### Step 4:

Terminal converts the digital audio data into character information by using a speech recognition engine.

Terminal transmits the digital audio data to a speech recognition module, which applies an acoustic model and a language model to decode phonetic sequences into words.

Terminal receives a transcription such as “Recently I often forget where I put things and sometimes miss appointments” and displays it for confirmation.

Input: Digital audio data representing the user's voice.

Output: Character information string representing recognized text.

### Step 5:

Terminal acquires character information directly when the user uses text input mode.

Terminal displays a text input area and receives keyboard or touch input from the user.

Terminal stores the entered text in memory and presents it on the screen.

Input: Keystrokes or touch events representing letters and words.

Output: Character information string representing user-entered text.

### Step 6:

User confirms or edits the recognized or typed character information on the terminal.

User visually inspects the displayed text and, if necessary, modifies words or adds details, then indicates completion (for example, by pressing a send button).

Input: Initial character information and user editing operations.

Output: Finalized character information to be transmitted to the server.

### Step 7:

Terminal constructs an input information message for the server.

Terminal attaches metadata such as a user identifier, a timestamp, an input type flag (voice or text), and device-related information to the finalized character information.

Terminal structures this data into a message format, for example, a key-value structure.

Input: Finalized character information, user identifier, timestamp, device data.

Output: Structured input information message stored in terminal memory.

### Step 8:

Terminal transmits the input information message to the server via a communication network.

Terminal initiates a secure communication session and sends the message to a predetermined server endpoint.

Terminal handles communication errors and retransmits if necessary.

Input: Structured input information message.

Output: Network packets containing the message data delivered to the server.

### Step 9:

Server receives and validates the input information message from the terminal.

Server reads the received data from the network interface buffer and decodes the message structure.

Server checks the presence and format of mandatory fields such as user identifier, timestamp, and character information.

Input: Network packets containing structured input information.

Output: Validated input information stored in server memory; error status if validation fails.

### Step 10:

Server stores the input information as a user input record in a storage device.

Server assigns a unique record identifier and writes fields including user identifier, character information, timestamp, and input type into a persistent data structure.

Input: Validated input information in server memory.

Output: Persistent user input record with an associated record identifier in the storage device.

### Step 11:

Server collects user-related information relevant to the analysis.

Server retrieves profile data, historical risk levels, and previous input records from the storage device for the corresponding user identifier.

Server aggregates this information into a user-related context structure.

Input: User identifier and stored profile and history records.

Output: User-related information structure aggregated in server memory.

### Step 12:

Server collects additional information such as behavior information and biological information when available.

Server accesses logs from connected sensors, applications, or external services and reads values such as daily activity counts, sleep duration, or self-reported events.

Server compiles these values into an additional information structure.

Input: Data records from behavior and biological information sources.

Output: Additional information structure associated with the user.

### Step 13:

Server generates additional-information summary data from the additional information structure.

Server computes summary metrics, such as averages, variances, trends, and counts over a defined time window.

Server formats these metrics into a concise representation suitable for inclusion in a natural-language description.

Input: Raw additional information structure.

Output: Additional-information summary data expressed as numerical features and optional text phrases.

### Step 14:

Server generates a prompt sentence based on character information, user-related information, and additional-information summary data.

Server composes evaluation items (for example, extraction of risk patterns and calculation of a risk level) and an output format specification into a control text for the generative AI model.

Server inserts the user's character information and the additional-information summary into the prompt sentence.

For example, the server generates:
“You are an assistant that analyzes user language to assess dementia-related risk patterns. Analyze the following user text and detect and list all ‘risk patterns’ that may indicate a risk of cognitive function decline. For each pattern, provide (1) a short description, (2) one category from {memory issue, orientation issue, language issue, executive function issue, other}, and (3) a severity score from 1 (very mild) to 5 (very severe). Then estimate the overall risk level as low, medium, or high, and give a brief explanation in plain language that can be shown directly to the user. Additional information summary: number of recent forgetfulness events=5 per week; average sleep duration=5.5 hours; activity level=low. User text: Recently I often forget where I put things and sometimes miss appointments.”

Input: Character information, user-related information, additional-information summary data.

Output: Prompt sentence text prepared for the generative AI model.

### Step 15:

Server constructs input data for the generative AI model by combining the prompt sentence with the character information in a model-specific input format.

Server concatenates the prompt sentence and character information into a single sequence and applies tokenization to produce token indices.

Server converts token indices into numerical vectors using an embedding mapping.

Input: Prompt sentence text and character information.

Output: Model input data consisting of an ordered sequence of token embeddings.

### Step 16:

Server performs inference using the generative AI model with the constructed input data.

Server supplies the sequence of token embeddings to the model's input layer and processes them through the multiple transformer layers.

Server computes self-attention weights, intermediate activations, and final output token probability distributions according to the model's parameters.

Input: Token-embedding sequence representing the combined prompt sentence and character information.

Output: Sequences of output token probabilities and generated tokens representing analysis result text.

### Step 17:

Server obtains analysis result data by decoding the generative AI model's output.

Server selects the most probable tokens step-by-step, reconstructs them into text, and interprets the resulting text as structured content such as lists of risk patterns, categories, severity scores, and an overall risk level.

Server checks for adherence to the requested output format and resolves minor format deviations using parsing rules.

Input: Output token probabilities and tokens from the generative AI model.

Output: Analysis result text that includes risk patterns, categories, severity values, and a risk level.

### Step 18:

Server parses and normalizes the analysis result text into structured fields.

Server applies parsing logic to extract individual risk pattern descriptions, associated categories, severity scores, a risk level, and explanatory text.

Server maps each free-form risk pattern description to an internal category code and may normalize severity scores into a standardized range.

Input: Analysis result text from the generative AI model.

Output: Structured analysis result data containing normalized risk patterns, categories, severity values, risk level, and explanatory text.

### Step 19:

Server stores the structured analysis result data in the storage device with associated time-series information.

Server creates a new analysis record linked to the user input record and stores fields including risk patterns, risk level, timestamp, and references to any additional-information summary.

Server updates indexes for efficient retrieval by user and by time.

Input: Structured analysis result data and timestamp.

Output: Persistent analysis result record and updated time-series index entries.

### Step 20:

Server computes transition information of the risk level for the user.

Server retrieves multiple past analysis records for the user and arranges them chronologically based on timestamps.

Server calculates changes in risk level over time, such as trend direction, rate of change, and stability measures, and encapsulates this as transition information.

Input: Historical risk levels and timestamps from stored analysis records.

Output: Transition information representing time-based evolution of the user's risk level.

### Step 21:

Server generates output information including an explanatory sentence and action recommendation information based on the structured analysis result data and the transition information.

Server creates human-readable explanations that highlight newly detected risk patterns and trends in comparison with previous assessments.

Server determines recommendations, such as continued monitoring, lifestyle adjustments, or consultation with a specialized institution when the risk level exceeds a predetermined threshold.

Input: Structured analysis result data and risk-level transition information.

Output: Output information object containing explanatory text, risk level, risk patterns, and action recommendations.

### Step 22:

Server formats the output information for transmission to the terminal.

Server converts the output information object into a message structure suitable for network transfer, ensuring inclusion of all necessary fields and language settings.

Server may compress or otherwise optimize the representation to reduce data size.

Input: Output information object in server memory.

Output: Encoded output information message ready for network transmission.

### Step 23:

Server transmits the output information message to the terminal via the communication network.

Server sends the message through the network interface to the terminal's address, handling transmission control and error checking.

Input: Encoded output information message.

Output: Network packets carrying the output information delivered to the terminal.

### Step 24:

Terminal receives and decodes the output information message from the server.

Terminal reads the incoming data from the network stack, reconstructs the message structure, and stores the contained fields in memory.

Input: Network packets containing the server's output information.

Output: Decoded output information structure on the terminal side.

### Step 25:

Terminal presents the output information to the user via visual or auditory means.

Terminal displays the explanatory sentence, risk level, and recommended actions on the screen and optionally converts the text to speech for audio output.

Input: Decoded output information structure.

Output: Visual and/or audio presentation that informs the user of the analysis result and suggested actions.

### Step 26:

User reviews the presented analysis result and decides on subsequent actions.

User reads or listens to the explanations and recommendations and may choose to follow suggested steps such as contacting a specialized institution or performing continued periodic assessments using the system.

Input: Visual or auditory output provided by the terminal.

Output: User decisions and possible subsequent interactions with the system (for example, new inputs at a later time).

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented risk assessment systems that rely on rule-based screening or simple statistical scoring are not well suited for analyzing natural conversational speech in real time. Existing architectures generally process user input as short, manually entered questionnaires or structured form data, and therefore fail to exploit the rich contextual and semantic information embedded in free-form spoken language. As a result, such systems cannot reliably extract nuanced indicators relating to memory, behavior, and temporal orientation from everyday conversations, and thus provide limited support for early-stage cognitive risk detection.

Furthermore, known systems that interface with machine learning models, including generative artificial intelligence models, are typically designed to submit raw or minimally processed text to those models. These systems lack mechanisms to systematically construct context-aware prompt sentences that encode domain-specific output requirements, such as explicit risk levels, justification information, and machine-readable formats. Consequently, the interaction between the application logic and the generative artificial intelligence model is ad hoc, difficult to reproduce, and error-prone, which degrades the consistency and interpretability of the generated risk assessments.

In addition, conventional architectures generally treat each interaction as an isolated event and do not provide an integrated mechanism to store and aggregate risk indices over time, nor to detect long-term trends based on historical conversational data, behavior-related information, and health-related information. Without such longitudinal analysis, the underlying computer system is unable to refine its risk evaluation by leveraging temporal patterns or gradual changes in the user's condition.

There is therefore a need for a computer-implemented system that improves the way processors acquire and transform audio information into structured feature information, construct precise and reproducible prompt sentences for generative artificial intelligence models, and integrate model outputs into a history-aware risk evaluation pipeline. Such a system should enable more effective use of computational resources and machine learning capabilities by organizing unstructured spoken language into structured, model-ready inputs, and by automatically managing the resulting risk indices and notifications in a scalable, programmable manner. In particular, there is a need to technically improve the interaction between speech recognition components, natural language processing components, and generative artificial intelligence models so that the overall computing system can provide stable, explainable, and trend-aware risk assessments in real time.

The specific processing by the specific processing unit 290 of the data processing device 12 in Application Example 1 is realized by the following means.

The present invention provides a server comprising a processor configured to receive audio data from a terminal device that acquires voice information of a user and convert the audio data into character information using a speech recognition unit, to perform language processing including word segmentation, part-of-speech tagging, semantic analysis, and keyword extraction on the character information using a language processing unit so as to generate feature information including expressions relating to memory, actions, and time of the user, to construct, on the basis of the feature information and the character information, a structured prompt sentence to be input to a generative artificial intelligence model and to define, in the prompt sentence, an output format for risk evaluation and output conditions for explanatory information, to input the prompt sentence to the generative artificial intelligence model and obtain from the generative artificial intelligence model an analysis result including a risk level and a reason explanation, to calculate a numerical risk index on the basis of the analysis result and specify a risk pattern by comparing the numerical risk index with a predetermined threshold, to store the risk index and the analysis result as record information and detect a long-term change trend by calculating transitions of a plurality of risk indices at different times, to generate and transmit notification information to an information display device for staff and output guidance information relating to a response policy when the risk pattern or the change trend satisfies a predetermined condition, and to generate, by using the generative artificial intelligence model, a question sentence for additional input in accordance with at least one of the analysis result and the long-term change trend and control a dialogue by transmitting the question sentence to the terminal device. This enables a technically improved computer system that transforms unstructured conversational audio into structured, reproducible model inputs, coordinates interaction with a generative artificial intelligence model in a controlled and machine-readable manner, and performs history-aware, explainable risk evaluation and notification, thereby enhancing the efficiency, consistency, and reliability of computer-implemented cognitive risk assessment based on natural conversations.

The term “system” refers to an integrated arrangement of one or more computing devices, terminal devices, communication interfaces, and storage media that cooperate to perform the processing operations described in the claims.

The term “server” refers to an information processing apparatus including at least one processor and at least one memory, configured to receive, store, and process data, and to provide processing results to one or more external devices via a communication network.

The term “processor” refers to a hardware processing unit, such as a central processing unit, a microprocessor, or a processing core, configured to execute instructions and thereby implement the functional units and processing steps described in the claims.

The term “terminal device” refers to an electronic device, such as a robot, a portable information device, or a fixed information terminal, that is configured to acquire voice information of a user, transmit the acquired information to the server, and output information received from the server.

The term “voice information” refers to audio signals generated by speech of a user and captured by an audio input device such as a microphone.

The term “audio data” refers to digital data representing voice information of a user, including sampled and encoded waveform data suitable for processing by a computing device.

The term “character information” refers to text data obtained by converting audio data into symbols representing linguistic units, such as characters, words, or sentences, in a predetermined language.

The term “speech recognition unit” refers to a functional module implemented by hardware, software, or a combination thereof, that converts audio data into character information by applying speech-to-text processing.

The term “language processing unit” refers to a functional module implemented by hardware, software, or a combination thereof, that performs natural language processing on character information, including at least one of word segmentation, part-of-speech tagging, semantic analysis, and keyword extraction.

The term “word segmentation” refers to a process of dividing character information into basic lexical units such as tokens or words according to linguistic rules.

The term “part-of-speech tagging” refers to a process of assigning grammatical category labels, such as noun, verb, or adjective, to tokens obtained from character information.

The term “semantic analysis” refers to a process of determining meaning-related information from character information, including relationships among words, phrases, and sentences.

The term “keyword extraction” refers to a process of identifying words or phrases in character information that are relevant to a predetermined evaluation task, such as risk assessment.

The term “feature information” refers to structured data derived from character information, including one or more elements that characterize content of user speech, such as expressions relating to memory, actions, and time.

The term “expressions relating to memory” refers to textual segments or phrases in character information that indicate states or changes of remembering or forgetting events, facts, or experiences.

The term “expressions relating to actions” refers to textual segments or phrases in character information that indicate user activities, behaviors, or difficulties in performing such activities.

The term “expressions relating to time” refers to textual segments or phrases in character information that indicate temporal aspects such as frequency, recency, or duration of events or states.

The term “prompt sentence” refers to a structured text string prepared for input to a generative artificial intelligence model, the text string including instructions, context, or constraints that define how the generative artificial intelligence model is to generate output.

The term “generative artificial intelligence model” refers to a computational model, implemented by machine learning or statistical methods, that generates output information such as text in response to input information, and that is capable of producing new content based on learned patterns.

The term “analysis result” refers to output information generated by the generative artificial intelligence model in response to a prompt sentence, including at least a risk level and an explanation of reasoning related to that risk level.

The term “risk level” refers to a qualitative or categorical indicator representing a relative degree of risk that a predetermined condition, such as cognitive decline, may be present or may occur.

The term “reason explanation” refers to descriptive information indicating factors, indicators, or reasoning that support a risk level generated by the generative artificial intelligence model.

The term “numerical risk index” refers to a numerical value derived from the analysis result of the generative artificial intelligence model, representing a quantified form of risk used for comparison and threshold processing.

The term “risk pattern” refers to a classification or state determined by comparing a numerical risk index with at least one predetermined threshold, indicating whether a user belongs to a predefined risk category.

The term “predetermined threshold” refers to a reference value stored in a storage medium and used to determine whether a numerical risk index satisfies a condition associated with a particular risk pattern.

The term “record information” refers to stored data including at least one of the numerical risk index, the analysis result, and associated metadata such as timestamps and identifiers.

The term “long-term change trend” refers to a temporal pattern or tendency identified by analyzing transitions of a plurality of numerical risk indices or related indicators over different points in time.

The term “history management unit” refers to a functional module implemented by hardware, software, or a combination thereof, that stores record information over time and detects long-term change trends based on the stored information.

The term “notification information” refers to data representing a message, alert, or recommendation that is transmitted from the server to an external device to inform staff or other recipients of a risk pattern or long-term change trend.

The term “information display device” refers to an electronic apparatus, such as a display terminal, a portable terminal, or a workstation, that presents notification information or guidance information to a human operator.

The term “guidance information” refers to information that suggests or indicates a response policy, action, or recommendation to be taken with respect to a user in view of a risk pattern or long-term change trend.

The term “notification unit” refers to a functional module implemented by hardware, software, or a combination thereof, that generates notification information and transmits the notification information to an information display device or other destination.

The term “question sentence” refers to a text string representing an interrogative expression intended to solicit additional input or responses from a user in a dialogue.

The term “dialogue control unit” refers to a functional module implemented by hardware, software, or a combination thereof, that controls progression of a dialogue with a user by generating, selecting, or transmitting question sentences or other utterances to a terminal device.

In one embodiment, a server cooperates with at least one terminal and at least one user to implement a system for evaluating a cognitive risk based on natural spoken conversation. The server includes at least one processor, a main memory, a non-volatile storage device, and a network interface. The terminal includes at least one processor, a microphone, a loudspeaker, a display, and a network interface. The user speaks to the terminal in an unconstrained manner in a physical environment such as a retail store, and the server processes the resulting audio data using speech recognition, natural language processing, and a generative AI model in order to output a structured risk evaluation and guidance information.

The server uses a speech recognition engine to convert audio data received from the terminal into character information. In one specific configuration, the server uses a cloud-based speech recognition service such as a speech-to-text application programming interface executing on a remote computation platform. The terminal sends audio data in a defined audio format (for example, linear pulse-code modulation at 16 kHz) to the server, and the server forwards the audio data to the speech recognition engine. The speech recognition engine outputs character information as a sequence of Unicode characters representing the spoken utterances of the user.

The server uses a natural language processing library such as a statistical or neural model for tokenization, part-of-speech tagging, syntactic parsing, and named entity recognition. In one example, the server uses an open-source natural language processing library that provides a pre-trained language model for a target language. The server loads the language model into memory and applies it to the character information received from the speech recognition engine. The server thereby identifies tokens, grammatical categories, dependency relations, and semantic entities for each sentence.

The server generates feature information from the character information by applying domain-specific extraction rules and learned classification models. The server identifies expressions relating to memory, such as “I often forget” or “I cannot remember yesterday,” expressions relating to actions, such as “I get lost” or “I miss appointments,” and expressions relating to time, such as “recently,” “these days,” or “for the last few months.” The server associates each identified expression with metadata including sentence position, confidence score, and a semantic label. The server stores this feature information in a structured data format, such as a record with fields for memory-related phrases, action-related phrases, temporal references, and counts of such phrases.

The server constructs a prompt sentence to be input to a generative AI model on the basis of the feature information and the character information. The server uses a prompt generation module that applies a template-based construction procedure. In one example, the server inserts the original user utterance and the extracted features into a pre-defined pattern that instructs the generative AI model to output a risk level and a reasoning explanation in a predictable structure. For instance, the server may generate a prompt sentence such as:
“Analyze the following user statements about memory and daily life. Use the information to evaluate the risk of cognitive decline. Identify key indicators, assign a risk level (low, medium, high), and explain your reasoning in 2 to 3 sentences. User statements: ‘I often forget what I was going to do, and I can't remember what I ate yesterday.’ Extracted features: symptom keywords=forget, can't remember; frequency=often; time references=yesterday; functional impact=forget intended actions, cannot recall recent meals.”

By defining the structure and content of the prompt sentence, the server constrains the output behavior of the generative AI model, reduces ambiguity in the responses, and creates outputs that can be parsed reliably.

The server uses a generative AI model that implements a neural network architecture, such as a multi-layer transformer network including an embedding layer, multiple self-attention layers, feed-forward sublayers, and a final projection layer. The generative AI model is trained on a large corpus of text data using a pretraining objective such as next-token prediction. During training, the model minimizes a loss function such as cross-entropy error between predicted token distributions and actual tokens in the training corpus. The model updates its parameters using an optimization algorithm such as stochastic gradient descent with adaptive learning rate adjustment. The server may further adapt the generative AI model for the risk assessment domain using fine-tuning data that contain de-identified user statements labeled with risk levels and explanatory rationales. This fine-tuning process improves the alignment of the model outputs with the target evaluation task and increases the accuracy and stability of the risk classification.

The server sends the constructed prompt sentence to the generative AI model through an application programming interface. The generative AI model outputs a text response that includes at least one risk level and one explanation. The server parses the response to identify the risk level, such as “low,” “medium,” or “high,” and to extract a reasoning explanation.

The server then maps the qualitative risk level to a numerical risk index by using a deterministic mapping table stored in non-volatile memory. For example, “low” may map to 1, “medium” to 2, and “high” to 3. The server stores the numerical risk index and the textual explanation in a history database along with a timestamp and a user session identifier.

The server improves computational performance and reliability by structuring the interaction with the generative AI model through prompt sentences that encode explicit output requirements. This design allows the server to process model outputs using simple parsing routines instead of complex post-processing heuristics, thereby reducing processing time and error rates in downstream modules. The server further reduces communication load between the terminal and the server by transmitting compressed audio segments and minimal metadata rather than full conversational transcripts. The server performs most of the heavy language processing and model inference operations on a centralized node or a cloud computing platform that is optimized for vectorized computation and parallel processing on graphics processing units or tensor processing accelerators.

The server updates the risk index over time by aggregating results from multiple sessions.

The server stores a time series of risk indices for each user or anonymous session identifier in a database such as a relational data store or a key-value store. The server computes a long-term change trend by applying a time-series analysis algorithm, such as a moving average or linear regression, to the stored risk indices. The server thereby identifies whether the risk is increasing, stable, or decreasing over a selected time window. The server may also incorporate additional behavior-related information and health-related information into the stored records, including visit frequency, time-of-day patterns, or self-reported health events, and incorporate these into modified prompt sentences to be sent to the generative AI model.

The server generates notification information when the numerical risk index or the detected long-term change trend satisfies a predetermined condition. For example, if the current risk index equals or exceeds a predetermined threshold or if the slope of the trend line exceeds a threshold value, the server generates an alert message and sends it to an information display device used by staff. The server formats this message using a compact data structure that contains the risk level, a summarized explanation, and a recommended response policy. The server may generate a guidance phrase such as: “Customer shows elevated indicators of short-term memory difficulty over multiple visits. Please consider offering general information on consulting a professional healthcare provider.” The staff can then view this guidance on a tablet or workstation display.

The server generates follow-up question sentences using the generative AI model in order to control the dialogue conducted by the terminal. The server constructs prompt sentences that request context-appropriate, polite questions that further probe specific aspects of memory or daily functioning, while avoiding direct mention of medical terminology when such avoidance is configured. For example, the server may provide a prompt sentence such as:
“Based on the following user statement about memory, generate one polite follow-up question that further explores daily routines without mentioning medical or diagnostic terms. User statement: ‘Recently, I often forget where I put things at home.’”

The generative AI model responds with a candidate question, for instance: “Could you tell me how you usually keep track of important items at home, such as keys or a wallet?” The server transmits the generated question to the terminal. The terminal uses a text-to-speech engine running on the terminal or on the server to synthesize audio from the question sentence and outputs the audio through the loudspeaker. This mechanism enables dynamic adaptation of the conversation based on model-driven analysis, rather than fixed, predetermined scripts.

The terminal acquires voice information from the user by using a microphone coupled to an audio interface. The terminal converts analog signals of the user's voice into digital audio data, buffers the audio data in memory, and transmits the data to the server via a communication network such as a wireless local area network or a wired network. The terminal may perform local preprocessing, such as noise reduction and voice activity detection, in order to reduce bandwidth and processing load on the server. The terminal outputs server-generated audio responses and visual guidance on its display so that the user can interact in a natural and intuitive manner.

The user speaks naturally to the terminal without the need to operate input devices such as a keyboard or a touchscreen. The user may respond to questions such as “Could you tell me what you did last weekend?” or “How do you usually remember your appointments?” The user's responses are captured as continuous speech. The system thereby obtains linguistic data that reflect real-world cognitive function and daily behavior, rather than constrained questionnaire responses.

The server improves computer technology in several ways. First, by combining speech recognition, natural language processing, and a generative AI model with a structured prompt sentence and feature information, the server transforms unstructured audio streams into formally specified, model-ready inputs, thereby enabling deterministic and reproducible interactions with a probabilistic language model. This reduces ambiguity and error in system behavior and allows the server to execute a stable, repeatable pipeline on commodity hardware.

Second, by internalizing domain-specific constraints and output formatting requirements into the prompt sentence and by mapping qualitative outputs to numerical risk indices, the server creates a processing architecture that is optimized for downstream computation. The numerical risk indices are stored, aggregated, and compared with thresholds in a computationally efficient manner using simple arithmetic and indexing operations. This architecture shortens inference-to-decision latency and reduces memory consumption compared to systems that operate directly on unstructured text.

Third, by maintaining a history of risk indices and applying time-series analysis on the server, the system implements a data management technique that leverages longitudinal information. This improves accuracy and robustness of the risk evaluation and reduces false positives and false negatives in comparison with single-episode assessments. The server can, for example, ignore isolated high-risk measurements that are not consistent with the long-term trend, thereby reducing unnecessary notifications.

Fourth, by having the generative AI model produce follow-up questions according to clearly defined prompt sentences and internal rules, the server uses the model to dynamically adapt the dialogue strategy. This adaptation is not a mere automation of human decision-making; instead, the server applies a multi-layer procedure in which features, trend statistics, and evaluation thresholds are fed back into prompt construction. This closed-loop control of prompt content optimizes both informational gain (through targeted questions) and computing efficiency (by restricting unnecessary queries).

The server can implement various alternative embodiments. In one alternative, the server executes the generative AI model locally on a dedicated inference accelerator rather than relying on a remote service. The processor loads a trained transformer model into a local memory and performs inference by executing matrix multiplication operations on a graphics processing unit or a specialized neural accelerator. In another alternative, the server uses a hybrid architecture in which a lighter, distilled model is executed at the network edge to provide a preliminary risk index, and a larger model is invoked only when the preliminary index exceeds an intermediate threshold. This cascaded model architecture further reduces communication overhead, power consumption, and latency.

The server can also vary the internal representation of feature information. In one variation, the server embeds the extracted phrases into a vector space using a sentence embedding model and stores the embeddings alongside textual descriptors. The server may cluster or compare embeddings over time to detect semantic drift in the user's responses. This vector-based representation enables the server to execute fast similarity searches and anomaly detection on numerical data instead of repeatedly re-parsing raw text.

The server can apply different loss functions and training procedures for fine-tuning the generative AI model. For example, the server may apply a multi-task objective that includes cross-entropy loss for next-token prediction and an auxiliary classification loss for predicting risk level labels, and update model parameters using a gradient-based optimizer. The server may perform data augmentation techniques such as paraphrasing or back-translation on training sentences to improve the model's robustness to linguistic variation, thereby increasing reliability in real-world deployment.

The server thereby provides a concrete technical implementation in which speech recognition, natural language processing, and a generative AI model are integrated through structured prompt sentences, numerical risk indices, and history-aware trend analysis to achieve improved computational efficiency, accuracy, and stability. The combination of these components, together with specific data structures and control logic, results in a computer system that goes beyond mere automation of human mental tasks and instead improves the underlying operation of the computing infrastructure used for conversational risk assessment.

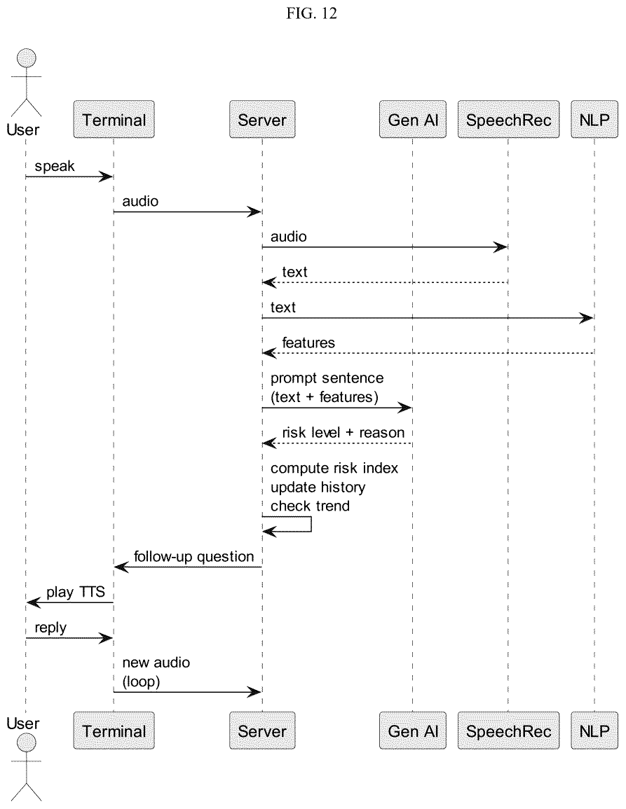

The following describes the processing flow using FIG. 12.

### Step 1:

Terminal captures audio from the user and transmits it to the server.

User speaks freely into a microphone of the terminal, for example in response to a question such as “Could you tell me what you did yesterday?” Input to this step is analog voice of the user.

Terminal converts the analog voice to digital audio data using an audio codec, segments the audio into frames (for example, 16 kHz, 16-bit PCM), and buffers the frames in memory.

Terminal may apply noise reduction and voice activity detection to remove background noise and non-speech intervals.

Terminal packages the audio frames into a data packet, adds metadata such as a session identifier and timestamp, and sends the packet via a communication interface to the server.

Output of this step is a stream of digital audio data and associated metadata delivered to the server.

### Step 2:

Server receives the audio stream and converts it to text.

Input to this step is the digital audio data and metadata from the terminal. Server verifies the audio format (sampling rate, bit depth, channel count) and, if necessary, resamples or re-encodes the audio using an audio processing library.

Server calls a speech recognition engine with the processed audio as input. The speech recognition engine performs acoustic modeling and language modeling to generate a sequence of tokens, and returns a transcription as character information.

Server receives the transcription, selects the hypothesis with the highest confidence score, and stores the transcription together with the session identifier and timestamp. Output of this step is character information representing the user's utterance.

### Step 3:

Server performs natural language processing and extracts feature information.

Input to this step is the character information from Step 2. Server passes the character information to a natural language processing library that executes tokenization, part-of-speech tagging, dependency parsing, and named entity recognition.

Server analyzes the parsed text to identify expressions relating to memory (for example, “I often forget,” “I can't remember”), actions (for example, “I get lost,” “I miss appointments”), and time (for example, “recently,” “yesterday,” “for several months”). Server uses rule-based patterns and classifier outputs to detect these expressions and assigns semantic labels and confidence scores.

Server aggregates the detected expressions into a structured record that includes lists of memory-related phrases, action-related phrases, temporal references, and counts or frequency indicators. Output of this step is feature information that summarizes the content of the user's utterance in a machine-readable format.

### Step 4:

Server constructs a prompt sentence for the generative AI model.

Input to this step is the feature information and the original character information. Server uses a template-based prompt generator to combine fixed instruction text with variable fields obtained from the feature information and the character information.

Server inserts the original user statements and the extracted features into the template and defines explicit output requirements, such as the requested risk levels and explanation format. For example, server generates a prompt sentence:
“Analyze the following user statements about memory and daily life. Use the information to evaluate the risk of cognitive decline. Identify key indicators, assign a risk level (low, medium, high), and explain your reasoning in 2 to 3 sentences. User statements: ‘I often forget what I was going to do, and I can't remember what I ate yesterday.’ Extracted features: symptom keywords=forget, can't remember; frequency=often; time references=yesterday; functional impact=forget intended actions, cannot recall recent meals.”

Server stores the constructed prompt sentence in memory for logging and further processing.

Output of this step is a structured prompt sentence ready for input to the generative AI model.

### Step 5:

Server sends the prompt sentence to the generative AI model and receives an analysis result.

Input to this step is the prompt sentence from Step 4. Server transmits the prompt sentence to a generative AI model via an application programming interface. The generative AI model, implemented as a trained neural network (for example, a transformer-based language model), processes the prompt by computing token embeddings, applying self-attention and feed-forward transformations layer by layer, and generating a probability distribution over possible next tokens at each decoding step.

Server receives the generated text output from the generative AI model, which includes at least a risk level (for example, “high”) and an explanation. Server parses the text to extract the risk level and the explanation section, using string matching or simple pattern rules defined in advance. Output of this step is an analysis result that contains a symbolic risk level and a natural language explanation.

### Step 6:

Server converts the analysis result into a numerical risk index and determines a risk pattern.

Input to this step is the analysis result from Step 5. Server maps the symbolic risk level to a numeric value by referencing a mapping table stored in memory, for example: low to 1, medium to 2, high to 3.

Server stores the numerical risk index together with the explanation, session identifier, and timestamp in a risk history database. Server compares the numerical risk index to a predetermined threshold; for example, if the threshold is 3, a risk index of 3 or higher is classified as “alert,” and a risk index below 3 is classified as “no alert.”

Server sets a risk pattern flag according to the comparison result, such as “normal,”“monitor,” or “high-risk.” Output of this step is a numerical risk index and a risk pattern classification associated with the current session.

### Step 7:

Server updates historical records and calculates a long-term change trend.

Input to this step is the numerical risk index and session metadata from Step 6, along with previously stored indices for the same user or session identifier. Server appends the current risk index to a time-ordered list of past indices and retrieves a window of recent indices from the database.

Server computes a trend measure, such as a moving average or regression slope, by applying arithmetic operations to the sequence of indices. For example, server may calculate the average risk index over the last five sessions and compute the difference between the current index and the historical average.

Server classifies the trend as “increasing,” “stable,” or “decreasing” according to comparison of the computed measures with predefined thresholds. Output of this step is an updated history record and a long-term change trend classification.

### Step 8:

Server generates notification information for staff when predefined conditions are met.

Input to this step is the risk pattern from Step 6 and the long-term change trend from Step 7.

Server evaluates a set of rules, such as: trigger an alert if the current risk pattern is “high-risk,” or if the trend is “increasing” and the average risk index exceeds a secondary threshold.

Server constructs notification information containing a concise summary of the risk level, the trend, and recommended actions. For example, server may generate a message: “Current risk level: high. Trend: increasing over last 3 visits. Recommendation: discreetly provide information on professional consultation.”

Server sends this notification information to an information display device for staff via a network protocol. Output of this step is a delivered alert or, if conditions are not met, a logged record indicating that no alert was issued.

### Step 9:

Server generates follow-up question sentences and controls the dialogue via the terminal.

Input to this step is at least one of the analysis result, the numerical risk index, and the long-term trend classification. Server constructs a new prompt sentence directing the generative AI model to propose a specific follow-up question. For example, server creates a prompt: “Based on the following user statement about memory, generate one polite follow-up question that further explores daily routines without mentioning medical or diagnostic terms. User statement: ‘Recently, I often forget where I put things at home.’”

Server sends this prompt sentence to the generative AI model, receives a candidate question in natural language, and verifies that the question satisfies basic constraints (such as length and absence of restricted terms). Server then transmits the approved question sentence to the terminal.

Terminal receives the question text, converts it to audio using a text-to-speech engine, and plays the audio through the loudspeaker. Output of this step is an updated conversational utterance output by the terminal, which elicits additional speech from the user.

### Step 10:

User responds to the follow-up question, and the system repeats the processing loop.

Input to this step is the question spoken by the terminal in Step 9. User answers naturally, providing new voice information that may include further details about memory, daily activities, or orientation.

Terminal captures this new speech as audio data, as in Step 1, and sends the audio to the server. Server then repeats Steps 2 through 9 for the new utterance, thereby refining the feature information, prompt sentences, analysis results, risk indices, and trends.

Output of this step is a continuous flow of updated inputs to the server's processing pipeline, enabling iterative improvement of the risk evaluation as more conversational data is collected.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented health support systems typically treat user health data, behavioral logs, and conversational inputs as separate and loosely coupled data streams. In many such systems, voice input is simply converted to text and stored, risk assessment is performed by a single statistical model on limited structured data, and feedback to the user is generated through fixed templates. As a result, several technical problems arise.

First, there is a low level of integration between different data modalities within the computing architecture. Voice-derived text, lifestyle logs, and health records are often processed by isolated software components, resulting in fragmented feature spaces and inefficient use of the available information. This architectural fragmentation leads to suboptimal model inputs, reduced accuracy of risk prediction, and poor adaptability of the system when user behavior changes over time.

Second, many existing systems rely either solely on a discriminative machine learning model or solely on a generative model, instead of combining them in a coordinated manner at the system level. Without a mechanism to systematically generate structured prompt sentences based on continuously updated multi-source data, generative models cannot fully exploit their natural language understanding capabilities. This causes instability and inconsistency in generated analyses and recommendations, and forces the system designer to implement ad hoc prompt construction logic dispersed across the code base.

Third, conventional systems often lack a feedback loop that uses objective performance data from interactive cognitive tasks to dynamically adjust both risk evaluation and content personalization. Brain training tasks, when present, are typically delivered with fixed difficulty or simple heuristics. There is no integrated mechanism in the processor to store execution results, update difficulty parameters in a machine-readable manner, and feed these updated parameters back into later analyses and prompt generation. This absence of a closed-loop control within the computing system leads to inefficient allocation of computational resources and an inability to adaptively tailor cognitive tasks to the user's evolving condition.

Fourth, existing architectures generally do not provide time-series handling of heterogeneous health and behavior data as a first-class computational concern. Many implementations perform snapshot-based analysis, ignoring temporal patterns and progression. Without an internal process for continuously acquiring, aggregating, and time-indexing user data, and without a corresponding time-series prompt generation mechanism, the system cannot effectively detect or model gradual cognitive changes at the machine level. This restriction limits the usefulness of risk estimation and undermines the ability of the system to support long-term monitoring with stable accuracy.

Accordingly, there is a need for an improved computer-implemented system in which a processor centrally coordinates (i) conversion of voice input into character information, (ii) aggregation and storage of lifestyle, behavior, and health information, (iii) construction of structured prompt sentences for a generative AI model, (iv) execution of a separate machine learning model to compute risk indices, (v) generation and adaptive control of brain training program information including difficulty parameters, and (vi) closed-loop time-series evaluation of cognitive function decline. By addressing these issues at the architectural and data-flow levels, the present invention aims to improve the technical performance, stability, and scalability of computer-based cognitive risk assessment and training systems, rather than merely automating a mental health workflow.

The specific processing by the specific processing unit 290 of the data processing device 12 in Example 2 is realized by the following means.

The present invention provides a server comprising a processor configured to process input information to convert voice information into character information, aggregate the character information and lifestyle, behavior, and health information, generate structured prompt sentences to be input to a generative AI model, cause the generative AI model to execute natural language processing based on the prompt sentences to identify risk patterns and analysis results related to cognitive function decline, manage an information storage unit that stores the lifestyle, behavior, and health information, perform numerical computation using a separate machine learning model to calculate a risk index relating to cognitive function decline from information retrieved from the information storage unit, select and generate brain function training program information including task parameters and difficulty parameters based on the risk index and the analysis results, transmit the brain function training program information and the analysis results to a terminal device, receive and record execution results of the tasks from the terminal device in the information storage unit, update the difficulty parameters based on the execution results, and generate additional prompt sentences for the generative AI model to produce response sentences including explanations and action guidelines for a user based on the risk index, the analysis results, and the task information. This enables an integrated computer architecture in which heterogeneous data streams are fused into coordinated prompt sentences and model inputs, generative and discriminative models are orchestrated by the processor within a unified control flow, time-series behavior and health information are systematically incorporated into risk evaluation, and brain training content is adaptively controlled in a closed loop, thereby improving the technical performance, consistency, and adaptability of computer-implemented cognitive function monitoring and support.

The term “processor” refers to a hardware computation unit or a combination of such units configured to execute instructions, perform data processing, and control operations of one or more software modules included in the system.

The term “voice information” refers to audio data representing spoken utterances of a user, including analog or digital signals that can be processed to recognize linguistic content.

The term “character information” refers to text data obtained by converting voice information or other inputs into a sequence of characters, symbols, or tokens interpretable by software components.

The term “input information” refers to data supplied to the system from one or more input sources, including but not limited to voice information, manual user inputs, and sensor-derived signals.

The term “lifestyle information” refers to data representing daily activities and habits of a user, including physical activity, nutrition, sleep, and other routine behaviors that may influence health.

The term “behavior information” refers to data describing observable actions or interaction patterns of a user, including application usage logs, task performance records, and response patterns in training programs.

The term “health information” refers to data related to the physical or cognitive condition of a user, including medical history, measurement values, questionnaire responses, and test results.

The term “prompt sentence” refers to a text string or structured natural language instruction generated by the system to be provided as input to a generative AI model to control the model's processing and output format.

The term “generative AI model” refers to a trained computational model that generates text or other content based on input prompts, using machine learning architectures capable of modeling probability distributions over sequences.

The term “natural language processing” refers to processing steps executed by software or hardware for interpreting, analyzing, or generating human languages in text form, including tasks such as classification, extraction, summarization, and dialogue generation.

The term “risk pattern” refers to a set of characteristics, features, or indicators identified from input data that correlates with a likelihood or level of cognitive function decline or related conditions.

The term “analysis result” refers to output information generated by the system that summarizes, explains, or quantifies findings from processing input data, including detected risk patterns and derived metrics.

The term “information storage unit” refers to a memory resource or storage subsystem that retains data, including lifestyle information, behavior information, health information, program parameters, and processing results, in an addressable and retrievable form.

The term “machine learning model” refers to a computational model generated by training on data to recognize patterns or make predictions, including models that perform numerical computations on feature vectors to output risk indices or classifications.

The term “risk index” refers to a numerical value or set of values computed by the machine learning model that quantitatively represents a level of risk associated with cognitive function decline for a user.

The term “brain function training program information” refers to data specifying one or more cognitive tasks, exercises, or games designed to stimulate or maintain cognitive functions, including associated parameters such as type, structure, sequence, and difficulty.

The term “task information” refers to structured data defining a specific cognitive or behavioral activity to be presented to a user, including instructions, content elements, scoring rules, and timing constraints.

The term “difficulty information” refers to parameters indicating complexity or challenge level of a task, such as number of items to remember, speed requirements, problem complexity, or other quantifiable difficulty factors.

The term “terminal device” refers to an end-user computing device, such as a mobile device, personal computer, or other user interface apparatus, configured to exchange data with the server and present information to the user.

The term “execution result” refers to data representing how a user performed a given task, including scores, completion status, elapsed time, error counts, and other performance metrics recorded during task execution.

The term “response sentence” refers to a natural language text output generated by or with the aid of a generative AI model, including explanations, recommendations, guidance, or other messages directed to a user.

The term “action guideline” refers to instruction content included in a response sentence that proposes specific behaviors or changes for the user to follow, such as adjustments to lifestyle, training frequency, or consultation with professionals.

The term “medical service provider” refers to an individual or organization qualified to offer medical or clinical services, including physicians, clinics, hospitals, or similar healthcare entities.

The term “time-series analysis prompt sentence” refers to a prompt sentence that explicitly incorporates user data associated with multiple time points and instructs the generative AI model to analyze temporal trends, progression, or future risk.

The term “progression degree” refers to an assessment of how much cognitive function decline has advanced over a period, expressed qualitatively or quantitatively based on time-series data.

The term “future risk” refers to a predicted likelihood or level of cognitive function decline at a later time, determined from current and historical data using analytical or predictive processing.

In one embodiment, a server implements the claimed system as a network-accessible cognitive function support platform. The server comprises at least one processor, a main memory, a non-volatile storage device, a network interface, and an information storage unit implemented by a database management system. The server executes a plurality of software modules including an operating system, a web application framework, an application program that implements the risk evaluation and training logic, a machine learning runtime library, and a communication library for interacting with a generative AI model.

The server uses general-purpose computing hardware, such as a multicore central processing unit and, in some embodiments, a graphics processing unit configured for matrix operations.

The server executes an operating system such as a general-purpose server operating system.

On top of the operating system, the server runs an application layer implemented, for example, using an application framework in a high-level programming language. The server accesses the information storage unit via a relational database management system.

A terminal operates as an end-user device and may be implemented by a smartphone, a tablet computer, or a personal computer. The terminal comprises a processor, a memory, an audio input device such as a microphone, a display, one or more user input devices such as a touch panel or keyboard, and a network interface. The terminal executes an application program that provides a graphical user interface to the user, acquires voice information and other inputs from the user, formats the input information, and exchanges requests and responses with the server via a communication network.

A user interacts with the terminal by providing voice information, lifestyle information, behavior information, and health information. The user also performs brain function training tasks presented by the terminal and receives feedback messages generated by the server.

In one configuration, the server converts voice information from the user into character information. The terminal first captures analog audio signals representing the user's spoken utterances through the microphone and digitizes the audio signals into digital samples using an analog-to-digital converter and an audio driver. The terminal packages the digitized audio as audio frames and sends the audio frames to the server over a secure communication channel.

The server receives the audio frames and executes an automatic speech recognition module implemented by a neural network-based acoustic model and a language model. The server extracts acoustic features from the audio frames, such as Mel-frequency cepstral coefficients, and feeds these feature vectors into a deep neural network that includes multiple layers of linear transformations and non-linear activation functions. The neural network outputs phoneme probabilities or character probabilities over time. The server combines these probabilities with a statistical language model or a neural language model using a decoding algorithm, such as beam search, to obtain a sequence of recognized characters or words. The server stores the resulting character information as text data in the information storage unit and associates it with a user identifier and a timestamp.

The server also acquires lifestyle information, behavior information, and health information from the terminal. The terminal obtains these data through user interaction with the graphical user interface. For example, the user may input the number of steps walked per day, approximate caloric intake, sleep duration, and qualitative dietary patterns using text fields, sliders, and selection lists on the terminal. The terminal may additionally collect behavior information, such as the number of training sessions completed and response times in cognitive tasks, by monitoring user interactions with brain function training tasks. Health information may be manually entered by the user or obtained from external medical sensors or health applications. The terminal structures these data as key-value pairs or records, attaches metadata such as time and device information, and sends them to the server over a network protocol.

The server aggregates the character information and the lifestyle, behavior, and health information in the information storage unit. The server organizes the information into interrelated tables or collections indexed by user identifiers and time. For example, one table may store daily lifestyle summaries, another table may store game performance logs, and another table may store recognized conversation text. The server uses this structured organization to efficiently retrieve and update data using indexed queries. This structured aggregation reduces redundant data access, improves cache utilization within the database system, and thereby enhances processing throughput when evaluating risk for a large number of users.

The server generates one or more prompt sentences for a generative AI model based on the aggregated data. The server implements a prompt construction module that applies deterministic rules to transform internal machine-readable records into human-readable natural language instructions. The server first computes intermediate features from the raw data using numerical libraries. For instance, the server calculates mean and variance of daily steps, counts the frequency of days exceeding predetermined thresholds, and identifies patterns such as a decreasing trend in physical activity. The server also computes statistics from the conversation text, such as length of utterances, frequency of pauses, and repetition of certain terms, using natural language processing techniques including tokenization and part-of-speech tagging.

The server then converts these intermediate features into prompt sentences by inserting values into templates maintained in a template store. By performing this transformation using fixed templates and deterministic substitution rules, the server ensures that the resulting prompt sentences exhibit a predictable structure and format. This approach improves the stability of the generative AI model's output because the model receives prompts that adhere to a consistent style and ordering of information, reducing variance across requests.

In one example, the server generates the following prompt sentence for evaluating dementia risk from lifestyle patterns:
“You are an AI assistant that evaluates dementia risk based on lifestyle data.

User profile: Female, 65 years old, non-smoker, no diagnosed dementia.

Last 30 days: average 7,000 steps per day, average 1,900 kcal per day, diet is mostly vegetable-based with fish twice a week, sleeps 7 hours per night.

Please estimate the dementia risk level (low, medium, or high), explain the main factors affecting the risk, and propose three concrete and practical lifestyle recommendations in less than 200 words.”

In another example, the server generates a prompt sentence for user feedback:

“You are an AI health coach. The user's dementia risk model output is 0.45 (medium risk).

Recent habits: walking 5,000 steps per day, often skipping breakfast, eating processed foods for dinner 3 times per week, doing brain-training games 4 times per week with moderate scores.

Please write a friendly message to the user that explains what ‘medium risk’ means, praises positive behavior (brain-training), and suggests specific improvements to exercise and diet that are realistic for someone in their 60s.”

In a further example, the server generates a time-series analysis prompt sentence:
“You are an AI assistant helping doctors detect early cognitive decline signs.

Analyze the following conversation transcript between the user and a virtual coach. Identify any linguistic features (for example, word-finding difficulty, repeated questions, disorganized speech) that might be associated with early dementia.

Summarize the potential warning signs and list 5 follow-up questions that a medical expert could ask.

Transcript: [conversation text here].”

The server provides the prompt sentence to a generative AI model. In one embodiment, the generative AI model is a transformer-based neural network that has multiple self-attention layers, feedforward layers, and normalization layers. The generative AI model receives the prompt sentence as a sequence of tokens and converts each token into an embedding vector using an embedding matrix. The model then processes the embedding vectors through a series of multi-head attention mechanisms, where each attention head computes weighted sums of the embeddings based on attention scores derived from query, key, and value projections. These computations generate context-dependent representations of the input tokens. The model applies non-linear transformations and residual connections across layers and finally decodes the internal representations into an output token sequence representing an analysis or a response sentence.

The server controls the generative AI model by specifying parameters such as maximum output length, temperature, and top-k or top-p sampling thresholds. By tuning these parameters and by enforcing structured prompt construction, the server stabilizes the generative AI model's output and reduces randomness. The server receives the generated output text and parses it using pattern matching and regular expressions to extract structured fields such as risk level labels, bullet-point recommendations, and summary sentences.

In addition to the generative AI model, the server uses a separate machine learning model to compute a risk index related to cognitive function decline. In one embodiment, the server implements this machine learning model as a feedforward neural network comprising an input layer, one or more hidden layers, and an output layer. The input layer receives a feature vector that includes numerical features computed from the lifestyle, behavior, and health information, such as normalized daily steps, calorie intake, sleep duration statistics, variability measures, and training performance metrics. The hidden layers apply linear transformations using learned weight matrices and add bias vectors, followed by non-linear activation functions such as rectified linear units. The output layer uses a sigmoid or softmax function to produce a probability value that represents the risk index.

The server trains the machine learning model offline prior to deployment by using historical datasets that contain known labels for cognitive risk status. During training, the server uses a loss function such as cross-entropy loss and an optimization algorithm such as stochastic gradient descent with adaptive learning rate adjustment. The server computes gradients of the loss with respect to the model parameters and updates the weights and biases iteratively. The server may perform data augmentation and resampling to correct for class imbalance and may perform early stopping and cross-validation to prevent overfitting. Once the model achieves a desired accuracy, the server stores the trained model parameters in the non-volatile storage device and loads them into memory when the application starts.

At runtime, the server normalizes incoming feature vectors using precomputed scaling parameters and invokes the inference function of the machine learning model. The server performs matrix multiplications and activation functions using optimized numerical libraries that take advantage of vectorized operations and, in some configurations, hardware acceleration through the graphics processing unit. This improves inference speed and allows the server to handle real-time risk evaluation for many users simultaneously. The server interprets the risk index as a continuous value and maps it to categorical levels such as low, medium, and high according to threshold values determined during model calibration.

The server generates brain function training program information based on the risk index and the analysis result from the generative AI model. The server maintains a catalog of task information stored in the information storage unit. Each task has metadata describing its type, such as memory recall, attention shifting, or reaction time measurement, as well as parameters that control difficulty, such as number of items, allowed response time, level of distraction, and complexity. The server executes a selection algorithm that uses the risk index and past performance metrics to choose which tasks to assign to the user and at what difficulty levels.

The selection algorithm may incorporate non-linear rules that are not straightforward for a human to apply consistently. For example, the server may assign a higher weight to recent performance compared to older performance, apply an exponential decay to old scores, and compute a competence score per task type. The server then compares the competence score to target ranges for each difficulty level and adjusts difficulty parameters accordingly. By embedding these rules in code and running them on the processor, the server executes a non-conventional control strategy that continuously adapts tasks to the user's cognitive status in a way that would be difficult to perform manually and consistently.

The terminal receives the brain function training program information from the server and renders corresponding tasks on the display. The terminal uses a user interface framework to display visual elements such as tiles, letters, numbers, and timers, and to play audio hints.

The terminal records detailed execution results, including correctness of responses, reaction times for each input event, number of attempts, and task completion or abandonment. The terminal may apply a local timestamp and compress the data before sending it to the server to reduce communication bandwidth usage.

The server stores the execution results in the information storage unit and updates internal difficulty parameters. The server calculates summary statistics such as average score and standard deviation for each task type and models the learning curve by fitting a function across sessions. The server then updates the difficulty parameters used for future training program generation. This closed-loop configuration, in which task assignment depends on machine-evaluated performance stored and processed in the server, yields a dynamic adaptation mechanism that improves training efficiency and personalizes cognitive load more precisely than static or manually configured systems.

The server further generates response sentences for the user by constructing additional prompt sentences for the generative AI model. These prompt sentences may embed the risk index, categories, main findings from analysis, and current training plan. By encoding the technical state of the system into these prompt sentences, the server causes the generative AI model to generate explanations and recommendations that are synchronized with the system's internal models. For example, the server may generate a prompt that includes text such as:
“You are an AI health coach. The user's latest risk index is 0.32, categorized as low risk.

Recent activity: walking 8,000 steps per day on average, balanced diet with sufficient vegetables and fish, consistent sleep of 7.5 hours, brain-training scores improving over the last 4 weeks.

Please explain to the user why the risk is currently low, describe at least two habits that are especially beneficial, and provide two specific suggestions to maintain or slightly improve cognitive health, in a polite and encouraging tone.”

The generative AI model processes this prompt and outputs a response sentence. The server may perform post-processing on the generated sentence, such as checking for length constraints, removing prohibited terms, and inserting standardized disclaimers. The terminal then displays the response sentence to the user as part of a dashboard view, possibly along with charts and other visualizations.

In some embodiments, the server performs time-series analysis by generating prompt sentences that include chronological sequences of behavior and health information. The server may also compute derived features such as moving averages, slopes, and volatility indicators before embedding them into the prompt text. This structured use of time-series summaries enables the generative AI model to recognize temporal patterns and progression, while the separate machine learning model uses numerical representations of the same time-series data to adjust the risk index. By aligning both models via a common underlying data structure and explicit feature engineering, the server improves the consistency and interpretability of the overall system.

The described architecture yields several technical effects beyond mere automation of mental health assessment. Because the server aggregates multi-modal data in a unified storage schema and uses deterministic prompt construction aligned with feature computation, the system reduces inconsistency in the generative AI model's behavior and enhances reliability of generated content. The use of a separate, optimized machine learning model for numerical risk index computation improves computational efficiency and prediction accuracy compared to relying solely on free-form generative outputs. The closed-loop control of brain function training tasks, based on machine-evaluated performance metrics and structured difficulty parameters, optimizes training schedules and reduces unnecessary user load.

In addition, by implementing feature extraction, model inference, and prompt generation using vectorized numerical operations, optimized storage indexing, and controlled communication protocols, the server decreases processing latency and bandwidth consumption. For example, the server can cache intermediate feature vectors and partial risk computations, and can compress data before transmission, thereby limiting network load. The server's separation of character information processing, structured data analysis, and generative AI prompting allows parallelization across processor cores or distributed nodes, which further enhances scalability and throughput.

Alternative embodiments may differ in specific implementation details while remaining within the scope of the claims. In one embodiment, the server may use a recurrent neural network or a convolutional neural network instead of a transformer-based model for particular sub-tasks, such as speech recognition or time-series classification. In another embodiment, the machine learning model for risk index computation may be a gradient boosting ensemble or a probabilistic graphical model rather than a feedforward neural network. In some configurations, the generative AI model may be hosted on a separate computing infrastructure and accessed via an application programming interface, while in other configurations, the model may be deployed locally on the same server hardware.

In further embodiments, the terminal may perform certain preprocessing locally, such as on-device speech recognition or partial feature computation, and send preprocessed results to the server to reduce network usage and server load. The system can also incorporate additional sensors such as accelerometers, heart rate monitors, or environmental sensors, and integrate their outputs into the same feature extraction and storage framework. These variations demonstrate that the system is not limited to a particular implementation, but rather to the coordinated architecture in which the server, the terminal, and the user interact, and in which the processor orchestrates structured data aggregation, generative AI model prompting, machine learning-based risk computation, and adaptive training control to enhance the technical performance of cognitive function monitoring and support.

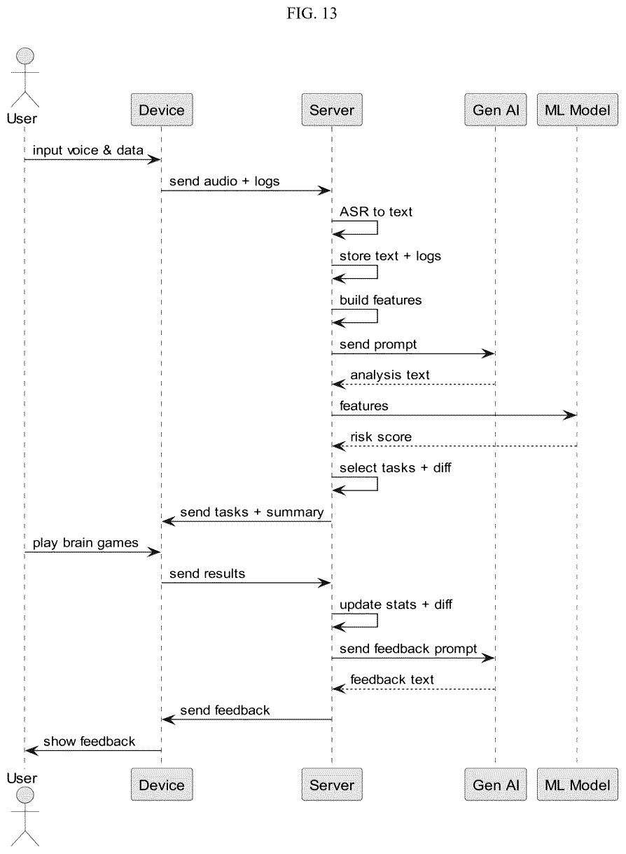

The following describes the processing flow using FIG. 13.

### Step 1:

The user provides input information to the terminal.

The user speaks into a microphone of the terminal and also enters lifestyle, behavior, and health information via a graphical user interface. The input includes voice information (audio waveform), numerical values such as daily steps and calories, categorical selections such as exercise type, and text fields describing meals or symptoms. The terminal converts the analog audio into digital audio samples, stores the structured input values in memory, and displays confirmation screens to the user. The output of Step 1 is a set of raw input data on the terminal, including digitized audio data and structured lifestyle, behavior, and health records.

### Step 2:

The terminal transmits the raw input data to the server.

The terminal packages the digitized audio data and structured numeric and text fields into request messages and attaches metadata such as user identifiers and timestamps. The terminal performs data compression if necessary and sends the messages to the server over a secure communication channel using a network protocol. The terminal uses an HTTP client to create request headers and bodies, encrypts the communication, and handles transmission errors via retries. The input to Step 2 is the raw input data created in Step 1, and the output is a set of network requests carrying audio frames and structured records delivered to the server.

### Step 3:

The server converts the voice information into character information.

The server receives audio frames from the terminal and buffers them in memory. The server applies a feature extraction algorithm to the audio samples to compute acoustic feature vectors, such as spectral coefficients, for each time frame. The server feeds the feature vectors into an automatic speech recognition neural network that outputs probability distributions over characters or phonemes. The server executes a decoding algorithm to select the most probable sequence of characters and assembles them into a text string. The input to Step 3 is the digitized audio data from the terminal, and the output is character information stored as text associated with the user.

### Step 4:

The server stores and organizes lifestyle, behavior, health, and character information.

The server receives structured lifestyle, behavior, and health records from the terminal together with the character information generated in Step 3. The server validates data types and ranges, converts date and time fields into a normalized format, and assigns internal identifiers. The server inserts the records into an information storage unit using database operations, organizing them into tables keyed by user identifier and time. The input to Step 4 is a set of validated records from network requests and recognized text output, and the output is a set of stored entries in the information storage unit, indexed for efficient retrieval.

### Step 5:

The server computes feature vectors from the stored information.

The server retrieves relevant records from the information storage unit for a specified time window, such as the last 30 days of lifestyle logs and recent brain training results. The server aggregates numerical fields to compute averages, variances, trends, and counts, and applies text processing to character information to extract statistics such as utterance length and repetition frequency. The server organizes these computed quantities into structured feature vectors for further processing. The input to Step 5 is stored lifestyle, behavior, health, and character data, and the output is a set of feature vectors representing the user's condition and history.

### Step 6:

The server generates a prompt sentence for a generative AI model.

The server takes the feature vectors and associated user profile data and maps them to natural language templates. The server inserts numeric values, categorical labels, and short summaries into predefined sentence structures to create a coherent narrative description of the user's state. The server concatenates these sentences with explicit instructions about the desired output format of the generative AI model. The input to Step 6 is the feature vectors and user metadata from Step 5, and the output is a prompt sentence in text form suitable for input to the generative AI model.

### Step 7:

The server transmits the prompt sentence to the generative AI model and receives generated text.

The server sends the prompt sentence to a generative AI model via an application programming interface, specifying parameters such as maximum response length and randomness controls. The generative AI model processes the prompt sentence internally and returns a generated text response that contains analysis, risk descriptions, and recommendations. The server receives this text response, checks its length and content for compliance with internal rules, and extracts key phrases or labels using pattern matching. The input to Step 7 is the prompt sentence from Step 6, and the output is generated analysis text and derived structured elements such as labeled risk patterns.

### Step 8:

The server computes a numerical risk index using a machine learning model.

The server selects a subset of the feature vectors emphasizing quantitative lifestyle, behavior, and health measures and normalizes them according to predetermined scaling parameters.

The server feeds the normalized vectors into a machine learning inference engine that applies matrix multiplications and activation functions to produce output probabilities or scores. The server interprets the output score as a risk index for cognitive function decline. The input to Step 8 is the normalized feature vectors, and the output is a risk index and associated category such as low, medium, or high risk.

### Step 9:

The server generates brain function training program information.

The server inputs the risk index, the generated analysis text elements, and recent task performance metrics into a selection algorithm. The server evaluates rules that determine which task types to assign and at what difficulty parameters, for example increasing memory task length when performance is high and risk is elevated. The server constructs a description of selected tasks, including identifiers, task types, and difficulty information. The input to Step 9 is the risk index, analysis results, and execution statistics, and the output is brain function training program information describing a set of tasks to be executed on the terminal.

### Step 10:

The server sends training program information and analysis results to the terminal.

The server packages the brain function training program information together with summarized analysis results into a response message. The server formats the data in a machine-readable structure and transmits the message to the terminal over the communication network. The server may compress or batch multiple updates to reduce bandwidth usage. The input to Step 10 is the program information and analysis text created in Step 9 and Step 7, and the output is a delivered configuration for tasks and analysis content available on the terminal.

### Step 11:

The terminal presents brain function training tasks to the user and records execution results.

The terminal receives the program information and decodes the task descriptions. The terminal initializes task modules corresponding to specified types and difficulty levels and displays interactive interfaces such as memory grids, timed quizzes, or attention-shifting exercises. The user performs the tasks by interacting with the interface, producing events such as taps, clicks, or keypresses. The terminal measures reaction times, counts correct and incorrect responses, and determines whether tasks are completed within specified conditions. The input to Step 11 is the program information received from the server, and the output is a set of detailed execution results captured on the terminal.

### Step 12:

The terminal transmits execution results to the server.

The terminal compiles execution results, including performance metrics, timestamps, and task identifiers, into structured records. The terminal optionally aggregates results from multiple tasks in a session and may perform local calculations such as average response time to reduce data volume. The terminal sends these records back to the server using secure network communication. The input to Step 12 is the raw execution data recorded during task performance, and the output is a set of execution result messages delivered to the server.

### Step 13:

The server updates stored performance records and adjusts difficulty parameters.

The server receives execution result records from the terminal and validates the data. The server inserts the results into the information storage unit, associating them with corresponding user identifiers and task identifiers. The server recalculates summary statistics such as moving averages of scores and rates of change in performance. Based on these recalculated statistics, the server modifies the difficulty parameters stored for each task type, for example increasing or decreasing difficulty levels. The input to Step 13 is the execution result records from Step 12, and the output is updated performance records and updated difficulty parameters used in future program generation.

### Step 14:

The server generates a user-facing response sentence using a new prompt sentence.

The server prepares a new prompt sentence that summarizes the current risk index, key patterns found in analysis, and recent training progress. The server embeds this information into a natural language instruction that asks the generative AI model to produce an explanation and action guideline appropriate for the user. The server then sends this prompt sentence to the generative AI model and receives a generated response sentence. The input to Step 14 is the risk index, analysis summaries, and performance aggregates, and the output is a natural language response sentence tailored to the user's current state.

### Step 15:

The server delivers the response sentence to the terminal.

The server packages the response sentence, and optionally associated structured annotations such as tags or headings, into a message for the terminal. The server sends this message over the network, ensuring reliable delivery. The input to Step 15 is the response sentence generated in Step 14, and the output is a display-ready message containing explanations and recommendations accessible to the terminal.

### Step 16:

The terminal displays the response sentence and updated information to the user.

The terminal receives the message from the server and parses the response sentence and any associated metadata. The terminal renders the text on the display, possibly alongside charts of the risk index trend and summaries of training performance. The user reads the explanations and recommendations and may modify behavior or choose to start new training tasks in response. The input to Step 16 is the response message from the server, and the output is a human-perceived presentation of analysis, risk status, and guidance that informs the user's subsequent interactions with the system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dementia risk-assessment and prevention support systems typically rely on fixed questionnaires, rule-based scoring, or simple statistical models. These systems present several technical problems when implemented in a real-world computing environment.

First, a conventional server generally treats heterogeneous user data streams such as audio input, free-text complaints, activity logs, dietary logs, emotion indicators, and expenditure records as separate, weakly related data sources. The server often lacks a unified representation that can be provided to an analysis engine in a consistent way. As a result, the server cannot effectively correlate linguistic patterns, time-series behavior signals, and contextual financial behavior, which limits the accuracy and robustness of risk detection. From a computing perspective, the server fails to leverage cross-modal information, and the processing pipeline becomes fragmented and difficult to scale or adapt.

Second, conventional systems tend to hard-code analysis logic inside application code or simple models. When a new data type is introduced (for example, emotion information or expenditure information), developers must redesign feature extraction logic, modify database schemas, and update rule engines. This tightly coupled architecture makes the system brittle and hinders iterative improvement. In particular, the server is not configured to dynamically construct machine-understandable instructions for an advanced analysis engine, such as a generative AI model, based on current data context. This leads to poor reuse of core analysis components and increases computational overhead due to duplicated or ad-hoc processing.

Third, existing systems often provide only static or generic feedback to users, without generating personalized prevention programs that adapt to both a user's cognitive risk and emotional state. The server typically computes a risk score and simply displays it, but does not automatically generate detailed, context-aware prevention and support programs, nor does it manage real-world activities or services associated with those programs. Consequently, the system does not close the loop between analysis and intervention, and does not continuously refine stored behavior and health data based on the actual execution results of recommended activities. From a computer-system viewpoint, this means that the server does not exploit feedback data to improve subsequent computation, and the data pipeline remains one-directional and under-utilized.

Fourth, in many conventional architectures, privacy and security are treated as an add-on layer. Behavior information, health information, emotion information, and expenditure information are sometimes transmitted via heterogeneous channels, without a unified, processor-level mechanism that enforces encrypted communication for all such data streams. This fragmented handling of security can expose sensitive data to risk and complicate the system's design, since multiple independent components manage encryption inconsistently, increasing both implementation complexity and the chance of configuration errors.

Fifth, existing systems generally do not integrate financial-behavior analysis with cognitive-risk analysis in a unified computational pipeline. Even when expenditure data is available, it is rarely correlated, at a processor level, with time-series changes in health and behavior information and with emotional signals. As a result, the server does not compute a risk-aware financial-advice output that reflects cognitive decline risk, and cannot generate system-level, automatically derived instructions for expenditure suppression or review. This represents an unexploited dimension of data that, if properly integrated, could improve both the technical performance of risk detection and the overall usefulness of the system.

Therefore, there is a need for a technical solution in which a processor is configured to: (i) convert audio information into character information; (ii) unify character information with behavior, health, emotion, and expenditure information; (iii) automatically construct context-dependent prompt sentences for a generative AI model; (iv) use the generative AI model to identify risk patterns and emotional states; (v) generate structured evaluation information and personalized prevention and support programs; (vi) manage reservations and participation for physical activities and services associated with those programs; (vii) accumulate execution results as behavior and health information; and (viii) consistently secure all sensitive information via encrypted communication. Such a configuration improves the internal operation of the server and the overall computing system by enabling modular, scalable, and context-aware processing of heterogeneous user data, and by automatically closing the loop between analysis, intervention, and feedback.

The specific processing by the specific processing unit 290 of the data processing device 12 in Application Example 2 is realized by the following means.

The present invention provides a server comprising a processor configured to process audio information to generate character information by using a sound recognition unit that converts the audio information into the character information, to generate a prompt sentence to be input to a generative artificial intelligence model based on at least part of the character information and at least part of one or more of behavior information, health information, emotion information, and expenditure information, and to input the prompt sentence together with the character information and the one or more kinds of information to the generative artificial intelligence model; to analyze, by using the generative artificial intelligence model, the character information and the one or more kinds of information included in the prompt sentence, to identify a risk pattern related to cognitive decline and an emotional state, and to generate evaluation information including a risk index and recommended actions based on an analysis result; to select or generate, based on the evaluation information, a prevention program including at least one of exercise, dietary management, and cognitive function training, and a support program corresponding to the emotional state, and to provide the prevention program and the support program to a user information processing apparatus; to manage reservation information and participation status regarding activities or service usage in a physical space that are related to the prevention program and the support program, and to store results of execution of the activities or the services as at least part of the behavior information or the health information; and to transmit and receive the behavior information, the health information, the emotion information, and the expenditure information between the server and the user information processing apparatus by using encrypted communication and to secure information safety by the encrypted communication. This enables the server to implement an integrated, computer-centric pipeline in which heterogeneous user data are normalized and combined into context-rich prompt sentences for the generative AI model, advanced analysis is performed to derive structured risk and recommendation outputs, personalized prevention and support programs are automatically generated and linked to real-world activities, feedback from those activities is reintegrated into the behavior and health data store, and all sensitive data flows are consistently protected via a unified encrypted-communication mechanism, thereby improving the technical performance, scalability, and security of the dementia risk-assessment and support computing system.

The term “audio information” refers to information representing sound, including a user's spoken utterances, captured by an input device such as a microphone and processed as an analog or digital signal.

The term “character information” refers to information representing text obtained by converting audio information or other inputs into a sequence of characters according to a language, including words, symbols, and punctuation.

The term “sound recognition unit” refers to a hardware component, a software component, or a combination thereof that converts audio information into character information by applying speech recognition processing.

The term “behavior information” refers to information indicating a user's actions in daily life, including but not limited to movement patterns, physical activity, participation in events, and usage of services.

The term “health information” refers to information indicating a user's physical or mental condition, including medical history, vital signs, lifestyle habits such as exercise and diet, test results, and other clinically relevant data.

The term “emotion information” refers to information indicating a user's emotional state, such as levels of anxiety, stress, sadness, joy, or calmness, derived from input data including voice, text, or sensor signals.

The term “expenditure information” refers to information indicating a user's monetary spending behavior, including payment records, purchase categories, transaction amounts, and time-series patterns of financial outflow.

The term “generative artificial intelligence model” refers to an information-processing model implemented by software, hardware, or a combination thereof, which is trained using data and configured to generate or transform information, and which performs natural-language processing or related operations in response to a prompt sentence.

The term “prompt sentence” refers to a text instruction that is input to a generative artificial intelligence model and specifies an operation to be performed by the model, the prompt sentence including at least part of character information and at least part of one or more of behavior information, health information, emotion information, and expenditure information.

The term “risk pattern” refers to a pattern of features or conditions detected from character information and other kinds of information, which is associated with an increased likelihood of cognitive decline or related health risks.

The term “emotional state” refers to a categorized or quantified condition of a user's emotion, such as anxious, stressed, calm, or depressed, identified based on emotion information.

The term “evaluation information” refers to information generated by analysis using the generative artificial intelligence model, including at least a risk index and recommended actions, and optionally including factors contributing to a detected risk pattern.

The term “risk index” refers to a qualitative or quantitative indicator included in evaluation information and representing the degree of cognitive decline risk or related health risk for a user.

The term “recommended actions” refers to actions suggested in evaluation information for reducing, managing, or monitoring a detected risk, including lifestyle changes, use of programs, or consultation with a professional.

The term “prevention program” refers to a structured set of instructions or content for preventing or delaying cognitive decline, including at least one of exercise content, dietary management content, and cognitive function training content.

The term “support program” refers to a structured set of instructions or content that is adapted to a user's emotional state and assists the user in coping with emotional or behavioral issues while supporting health-related goals.

The term “user information processing apparatus” refers to an electronic apparatus such as a mobile terminal, a wearable device, or a general-purpose computing device operated by or associated with a user and configured to transmit and receive information to and from a server.

The term “activities or service usage in a physical space” refers to real-world actions performed by a user at a physical location, including participation in exercise sessions, health-promotion events, consultation services, or other in-person programs.

The term “reservation information” refers to information indicating a planned participation by a user in an activity or a service, including at least identifiers of the activity or service, time, location, and user.

The term “participation status” refers to information indicating whether and how a user actually joined an activity or used a service, including attendance, duration, and completion status.

The term “encrypted communication” refers to a communication method in which data exchanged between devices is transformed using a cryptographic technique such that the original data cannot be readily obtained by an unauthorized third party.

The term “instruction information” refers to information generated by a processor to prompt or recommend that a user take a specific action, including but not limited to consulting a medical institution or a specialist.

The term “medical institution” refers to an organization that provides health-care services, including hospitals, clinics, and similar entities authorized to deliver medical examination or treatment.

The term “specialist” refers to a person having expert knowledge or qualifications in a relevant field, such as medicine, psychology, or nutrition, and capable of providing professional advice or treatment.

The term “time-series change” refers to a variation in values of behavior information or health information observed over multiple points in time.

The term “correlation” refers to a statistical or logical relationship between two or more kinds of information, such as between time-series behavior information and emotion information or expenditure information.

The term “risk score” refers to a numerical value obtained by quantifying a risk of cognitive decline based on one or more kinds of information, the numerical value being usable for comparison or thresholding.

The term “advice information” refers to information that provides guidance or suggestions to a user, including recommendations relating to expenditure suppression or expenditure review according to a calculated risk score.

In one embodiment, a system includes a server and one or more terminals. The server includes at least one processor, a memory, a non-transitory storage medium, and a network interface. The terminal includes at least one processor, a memory, a user interface device, an audio input device, and a communication interface. The server and the terminal are connected via a communication network such as the Internet, and communicate using an encrypted transport protocol such as Transport Layer Security (TLS) over Hypertext Transfer Protocol (HTTPS).

Server executes a program stored in the memory to implement the functional units described below. The program is loaded from the non-transitory storage medium such as a magnetic disk, a solid-state drive, or a flash memory. Terminal also executes a program stored in its memory to implement local data capture, local preprocessing, and user interaction.

Server includes a sound recognition unit implemented by a speech recognition engine. In one embodiment, server uses a cloud-based or on-premises speech-to-text engine that applies an acoustic model and a language model to convert audio information into character information. The acoustic model is implemented as a deep neural network trained on a large set of speech waveforms and corresponding phonetic labels. The language model is implemented as an n-gram model or a recurrent neural network trained on text corpora. The sound recognition unit receives audio information encoded as a linear pulse-code modulation stream or a compressed format and outputs character information as a sequence of Unicode characters representing words and punctuation. By performing this conversion in a standardized manner, server normalizes heterogeneous audio inputs into a unified textual representation, which improves downstream processing consistency.

Terminal captures audio information using a microphone. Terminal digitizes the audio using an analog-to-digital converter and stores the digitized audio in a buffer in memory. Terminal attaches metadata such as sampling rate, number of channels, language code, and timestamp, and transmits the audio information to server through the communication interface. When the user prefers text input, terminal accepts typed character information via a keyboard or a touch interface and transmits the character information directly to server without performing audio capture.

Server stores the received character information in a text data store. Server also stores behavior information, health information, emotion information, and expenditure information in one or more databases. In one embodiment, server uses a relational database management system to store records in tables for user profiles, activity logs, health metrics, emotional states, cognitive assessments, financial transactions, and event participation. Each record is associated with a user identifier and a timestamp, enabling server to reconstruct time-series changes.

Server uses a natural-language preprocessor implemented in software libraries such as a tokenization module, a part-of-speech tagging module, and a syntactic parsing module.

Server converts the character information into tokens, assigns grammatical categories to the tokens, and builds a dependency tree representing grammatical relations. Server extracts linguistic features that are relevant to cognitive decline, such as mentions of forgetfulness, confusion, temporal disorientation, or difficulties with daily tasks. Server maps these features into feature vectors stored in memory. These feature vectors include binary indicators for specific symptom keywords, counts of temporal expressions, sentence length statistics, and syntactic complexity measures. By structuring the text as vectors, server enables efficient numerical processing by machine-learning algorithms.

Server uses an emotion analysis unit to derive emotion information from character information and optionally from prosodic features of the audio information. In one embodiment, server uses a neural-network-based classifier that receives as input either lexical features (word embeddings, sentiment lexicon scores) or acoustic features (pitch, energy, speech rate) and outputs probabilities for predefined emotional states such as “anxiety,” “sadness,” “calm,” and “stress.” The classifier is trained using supervised learning with labeled emotion datasets. The loss function is a categorical cross-entropy function, and weight parameters are optimized using gradient-based optimization with backpropagation.

Server stores the resulting emotion probabilities as emotion information associated with each interaction. This structured emotion information allows server to adjust later processing, including recommendation generation, according to the user's emotional state.

Server generates a prompt sentence for a generative AI model. Server assembles the prompt sentence from several components stored in memory. First, server retrieves the character information representing the latest user statement. Second, server retrieves relevant behavior information such as average daily steps over a recent period, frequency of exercise sessions, and participation in cognitive training events. Third, server retrieves health information including age, basic demographics, known medical conditions, and any recent health measurements. Fourth, server retrieves emotion information obtained by the emotion analysis unit. Fifth, server retrieves expenditure information such as recent spending patterns, spending categories, and anomalies relative to a baseline.

Server combines these pieces into a context-rich natural-language instruction specifying the analysis or generation task for the generative AI model. In one embodiment, server uses a programmable template in which variable fields are filled with current data values. An example of a prompt sentence is:
“Analyze the following user profile and recent statement to evaluate dementia risk and identify early indicators. Then estimate the overall risk level (low, moderate, high) and explain the main reasons.

User profile: age 68, male, history of high blood pressure, physically inactive (average 3,000 steps per day), diet high in processed food.

Recent statement: ‘Recently, I forget many things and I am worried.’

Emotion: anxiety is high.

Provide the result as: risk level, key factors, and a brief recommendations summary.”

Server may also generate prompt sentences for generating prevention programs, for example:
“Create a one-week dementia-prevention plan for the following user: age 68, male, moderate dementia risk, low physical activity, high anxiety, high intake of processed food.

Include daily recommendations for: (1) physical exercise, (2) diet improvements, and (3) simple brain-training tasks that are not too stressful.

Output the plan as 7 days, where each day has ‘exercise’, ‘diet’, and ‘brain training’ recommendations.”

Furthermore, server may generate prompt sentences that integrate financial behavior with risk evaluation, for example:
“Analyze the following three months of categorized spending together with the user's dementia risk level (high) and emotional state (frequent anxiety). Detect any risky patterns such as unusually high impulsive purchases. Then generate three recommendations to help the user manage spending safely.”

Server inputs these prompt sentences, together with structured context data, into the generative AI model. In one embodiment, the generative AI model is implemented as a transformer-based neural network with multiple attention layers, trained on large natural-language corpora and domain-specific medical and behavioral texts. The model receives the prompt sentence as a sequence of token embeddings. The model applies self-attention mechanisms and feed-forward layers to compute contextualized representations of each token. The model then predicts output tokens that form a natural-language response or a semi-structured response according to the instructions in the prompt sentence.

Server configures the generative AI model with parameters such as the number of layers, the dimensionality of embeddings, the number of attention heads, and regularization settings. The training procedure uses a loss function such as a cross-entropy between predicted tokens and ground-truth tokens in the training data. During fine-tuning for the dementia-risk domain, server or a training system uses domain-specific datasets that link input descriptions to known risk levels and recommended actions, and updates model weights accordingly. Server may store the fine-tuned model on a dedicated accelerator device, such as a graphical processing unit or a tensor processing unit, to improve inference speed.

Server post-processes the output of the generative AI model. In one configuration, the model is instructed in the prompt sentence to produce a response in a structured textual format, such as labeled lines or simple key-value pairs. Server parses the response by detecting labels like “risk level:”, “key factors:”, and “recommendations:”. Server converts the parsed content into evaluation information that includes a risk index, a list of risk factors, and recommended actions. The risk index may be a discrete level such as “low,” “moderate,” or “high,” or a numeric value derived from the model's output. Server stores the evaluation information in the database, enabling subsequent retrieval and analysis.

Server optionally combines the qualitative output of the generative AI model with a quantitative machine-learning model that computes a numeric risk score from feature vectors.

In one embodiment, server uses a feed-forward neural network implemented with a machine-learning framework. The neural network receives as input a feature vector that includes demographic features (age, gender), health features (presence of certain conditions, blood pressure levels), behavior features (average steps, frequency of exercise), diet features (diet score), emotion features (average anxiety level over a period), linguistic features (presence of memory complaints), and expenditure features (measure of spending volatility).

The neural network has one or more hidden layers with non-linear activation functions such as rectified linear units. The final layer outputs a single value representing a probability of cognitive decline risk. The network is trained with supervised learning on labeled datasets that assign risk labels to historical examples, by minimizing a loss function such as mean squared error or cross-entropy and updating weights using gradient-based optimization.

Server combines this numeric risk score with the generative AI model's discrete assessment to form a robust risk index.

Server generates a prevention program based on the evaluation information. Server uses predefined program templates stored in the database and adapts them according to the user's risk index, behavior information, and emotion information. Server can also invoke the generative AI model to generate detailed program content, using a prompt sentence that instructs the model to produce daily schedules and activity descriptions. Server ensures that the generated program includes at least one of exercise, dietary management, and cognitive function training. For example, the program may specify “30 minutes of walking per day,” “reduce sugary snacks and increase vegetables,” and “perform a word-memory game for 15 minutes.” Server stores the generated program in a program table and assigns identifiers to individual tasks.

Server generates a support program corresponding to the user's emotional state. For example, if the emotion information indicates high anxiety, server selects or generates relaxation exercises, breathing techniques, or low-stress cognitive tasks. Server uses rule-based logic and generative AI outputs to balance cognitive load and emotional burden. By aligning program content with emotional state, server reduces the risk that the user will abandon the program and improves adherence, which in turn yields more reliable behavior and health information for future analysis.

Server manages reservations and participation for activities or services in a physical space. When the prevention program or support program includes participation in real-world events such as fitness classes or group cognitive-training sessions, terminal displays a list of available events obtained from server. User selects an event and a desired time. Terminal transmits reservation information including user identifier and event identifier to server.

Server checks availability in an event schedule table and creates a reservation record. When the event occurs, terminal records the user's attendance using a code scan or proximity detection and sends participation status to server. Server updates the behavior information and health information with data representing actual participation, such as duration of exercise and task completion. This closed loop enables server to refine future evaluation information and prevention programs based on real execution outcomes.

Server consistently uses encrypted communication for all transfers of behavior information, health information, emotion information, and expenditure information. In one embodiment, server and terminal perform a handshake to establish a secure channel using public-key cryptography. All application-layer messages are transmitted over this secure channel. By centralizing encryption handling in the network interface and processor logic rather than distributing it across multiple independent components, server reduces the chance of misconfiguration and ensures that sensitive information is uniformly protected.

Terminal functions as the user interface for presenting evaluation information, prevention programs, and support programs. Terminal receives structured data from server and renders it on a display. Terminal may show a main screen summarizing the risk index, a list of key risk factors, and overview recommendations. Terminal shows daily program tasks with checkboxes for completion. Terminal allows user to input feedback such as “completed” or “skipped” for each task. Terminal sends completion data back to server, which updates program adherence metrics and may recompute evaluation information. This bi-directional interaction creates a feedback mechanism that improves the accuracy and personalization of the system over time.

User operates the terminal to input audio information or character information, to review outputs, and to carry out the recommended activities. For example, user may say “Recently, I forget many things and I am worried” into the microphone. User may later view a message stating “Your recent forgetfulness and low physical activity indicate an increased risk. We recommend visiting a specialist and starting a daily walking and brain-training routine.” User may accept a suggested appointment or event reservation, and perform the indicated activities.

By integrating these components, server executes more than a generic sequence of data collection, analysis, and display. Server implements a specific data structure and processing flow in which heterogeneous data types are normalized, combined, and embedded into prompt sentences that guide a generative AI model. Because server structures the prompt sentences in a context-aware and task-specific manner, the generative AI model can return outputs that directly map to internal data structures such as evaluation information and program definitions. This reduces the need for complex rule-based parsing logic and improves processing speed. Additionally, the combined use of transformer-based natural-language processing and numeric risk models allows server to achieve higher detection accuracy than either approach alone.

The described architecture improves computer technology itself. Server reduces computational overhead by generating prompt sentences that already contain pre-selected, relevant features, rather than transmitting large raw datasets to the generative AI model. This reduces communication load and memory usage. Server improves data management by organizing information into normalized tables and feature vectors, enabling efficient retrieval and time-series analysis. Server achieves improved accuracy and robustness through multi-modal fusion of behavior, health, emotion, and expenditure information, which is not feasible with simple manual scoring. The combination of domain-specific feature engineering, model architectures, and prompt sentence design produces a technical effect of improved risk-assessment performance and personalized content generation.

In alternative embodiments, server may use different types of generative AI models, such as sequence-to-sequence models, encoder-decoder architectures, or hybrid models that incorporate structured medical knowledge bases. Server may vary the neural network architecture used for quantitative risk scoring, such as using convolutional layers to capture local patterns in time-series data or recurrent layers to model temporal dependencies. Server may also implement data augmentation techniques when training models, such as injecting noise into input features or performing random masking of tokens, to increase robustness.

These variations still rely on the fundamental mechanism of generating context-rich prompt sentences and using the generative AI model to produce evaluation information and programs.

In another embodiment, server deploys multiple generative AI models specialized for different tasks, such as one model for risk classification and another model for program generation. Server selects which model to invoke based on the type of prompt sentence. In a further embodiment, server caches intermediate representations and evaluation information to avoid redundant computation when similar inputs are received. This caching reduces response time and computational cost, further improving system performance.

In summary, server, terminal, and user cooperate in a system where server applies specific, structured data processing, machine-learning architectures, and prompt sentence generation to transform heterogeneous, security-sensitive user data into technically meaningful evaluation information and personalized real-world intervention programs, thereby improving the operation of the computer system itself and enabling technical effects such as accuracy improvement, processing efficiency, and secure, integrated data management.

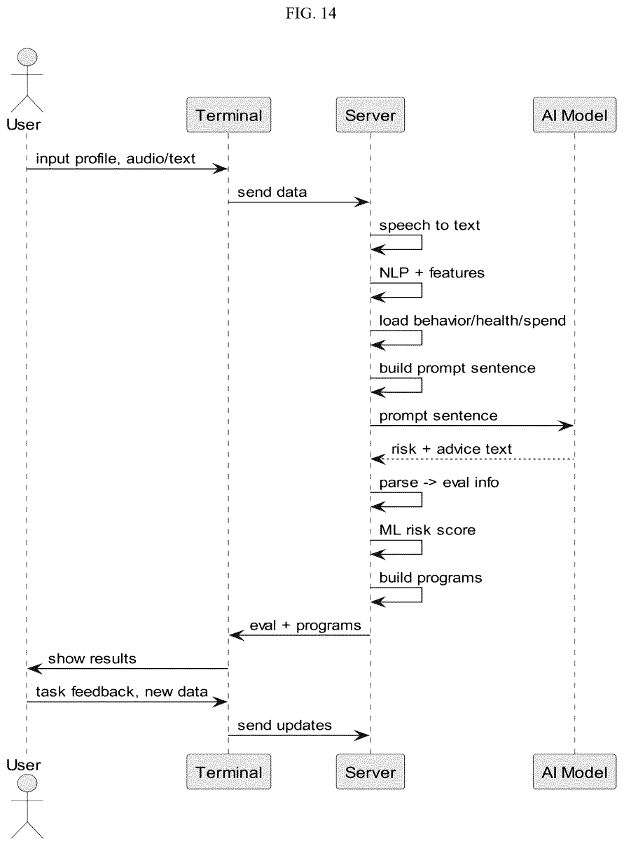

The following describes the processing flow using FIG. 14.

### Step 1:

User operates the terminal to provide initial information.

User inputs profile data such as age, sex, basic medical history, and lifestyle habits through graphical forms, and additionally provides audio information or character information describing cognitive concerns (for example, “Recently, I forget many things and I am worried”).

The input of this step is raw user profile fields and either raw audio waveforms or raw text entered at the terminal.

The output of this step is structured profile data and either an audio data object or a text data object stored in the terminal's memory and prepared for transmission.

### Step 2:

Terminal transmits captured data to the server.

Terminal packages the profile data, audio data, and/or text data into a structured message, for example a JSON document, and attaches metadata such as user identifier and timestamps.

Terminal then sends this message to server via encrypted communication using a secure protocol.

The input of this step is the structured profile data and raw communication-ready audio/text objects generated in Step 1.

The output of this step is a network payload delivered over the communication interface, which server receives as a request containing user profile and input content.

### Step 3:

Server converts audio information into character information.

Server determines whether the received message includes audio information. When audio is present, server calls a sound recognition unit that applies speech recognition to the audio. The sound recognition unit takes the audio waveform and performs acoustic feature extraction and language decoding to generate a text string.

The input of this step is the audio data object extracted from the network payload.

The output of this step is character information, namely a string of characters representing the user's spoken utterance, stored in server memory and associated with the user identifier. If the terminal already sent text, server uses that character information directly as the output.

### Step 4:

Server performs natural-language preprocessing of the character information.

Server tokenizes the character information into words and sentences, assigns part-of-speech tags, and builds a dependency structure. Server then extracts linguistic features such as the presence of memory-related terms, temporal expressions, and markers of confusion.

The input of this step is the character information produced or received in Step 3.

The output of this step is a linguistic feature vector and a set of symbolic tags (for example, “memory_complaint=true,” “disorientation=false”) stored in a text analysis data structure in server memory.

### Step 5:

Server derives emotion information from the user input.

Server applies an emotion analysis unit to either the original audio (using prosodic features) or the character information (using lexical and syntactic features). Server computes probabilities for predefined emotional states such as anxiety, sadness, or calmness, by applying a trained classifier to the extracted features.

The input of this step is, depending on configuration, the audio data and/or the character information, plus their derived features.

The output of this step is emotion information, represented as numeric scores or labels (for example, “anxiety=high, sadness =low”), which server stores in association with the current interaction.

### Step 6:

Server aggregates behavior, health, and expenditure information.

Server queries internal databases to retrieve behavior information (such as step counts, exercise frequency, and event participation), health information (such as age, medical history, and recent measurements), and expenditure information (such as categorized spending amounts and temporal patterns). Server compiles these values into structured records and time-series summaries.

The input of this step is the user identifier and retrieval parameters for the relevant time window (for example, last 90 days).

The output of this step is an aggregated user-state record containing numerical and categorical values for behavior, health, and expenditure information, stored as a feature bundle in memory.

### Step 7:

Server generates a context-rich prompt sentence for the generative AI model.

Server combines the character information, linguistic feature tags, emotion information, and aggregated behavior, health, and expenditure information into a single, task-specific natural-language instruction. Server fills template fields to construct a prompt sentence that describes the user's state and specifies the required analysis or generation.

The input of this step is the character information from Step 3, the linguistic feature vector from Step 4, the emotion information from Step 5, and the aggregated user-state record from Step 6.

The output of this step is a completed prompt sentence, for example:
“Analyze the following user profile and recent statement to evaluate dementia risk and identify early indicators. Then estimate the overall risk level (low, moderate, high) and explain the main reasons.

User profile: age 68, male, history of high blood pressure, physically inactive (average 3,000 steps per day), diet high in processed food.

Recent statement: ‘Recently, I forget many things and I am worried.’

Emotion: anxiety is high.

Provide the result as: risk level, key factors, and a brief recommendations summary.”

Server stores this prompt sentence as a text object in memory.

### Step 8:

Server invokes the generative AI model with the prompt sentence.

Server sends the prompt sentence to a generative AI model through an inference interface.

The model processes the tokenized prompt, applies its internal neural-network layers, and generates an output response describing risk assessment and recommendations.

The input of this step is the prompt sentence generated in Step 7.

The output of this step is the generative AI model's textual response, for example lines indicating “risk level: high,” “key factors:,” and “recommendations:,” which server receives and stores in a response buffer.

### Step 9:

Server parses the generative AI response and generates evaluation information.

Server analyzes the textual response from the generative AI model by detecting known labels and delimiters, and extracts structured fields such as the risk level, key risk factors, and recommended actions. Server optionally converts qualitative levels into internal codes or numeric indices.

The input of this step is the raw response text produced in Step 8.

The output of this step is evaluation information including at least one risk index and one or more recommended actions, stored in a dedicated evaluation record linked to the user.

### Step 10:

Server computes an optional quantitative risk score from feature vectors.

Server constructs a numeric feature vector using behavior, health, emotion, linguistic, and expenditure features. Server inputs this feature vector into a machine-learning model, such as a neural network, and obtains a numeric probability or score indicating cognitive decline risk.

Server may combine this numeric score with the qualitative risk index from the generative AI model.

The input of this step is the aggregated user-state feature bundle from Step 6 and possibly additional derived features.

The output of this step is a quantitative risk score, which server stores alongside the evaluation information to form a comprehensive risk index.

### Step 11:

Server generates a prevention program and a support program.

Server uses the evaluation information, including the risk index and emotion information, to select or generate program content. Server may call the generative AI model again with a program-generation prompt sentence that requests a daily plan of exercise, diet modifications, and cognitive training adapted to the user's emotional state. Server combines generated text with internal templates to produce structured tasks and schedules.

The input of this step is the evaluation information from Step 9, the risk score from Step 10, and the emotion information from Step 5.

The output of this step is a prevention program and a support program represented as data structures containing tasks, time allocations, and parameters, stored in a program database.

### Step 12:

Server manages reservations for physical activities and services.

Server analyzes the prevention and support programs to identify activities or services that occur in a physical space, such as classes or consultations. Server retrieves available event slots and, upon user request received from the terminal, creates or updates reservation records and participation schedules.

The input of this step is program content specifying physical activities, and reservation requests from the terminal including event identifiers and desired times.

The output of this step is an updated set of reservation information and participation status records stored in the event-management data store.

### Step 13:

Terminal receives and presents evaluation and program information.

Terminal obtains from server the evaluation information, prevention program, support program, and reservation details via encrypted communication. Terminal parses these data and renders them on the display as summaries, task lists, calendars, and detailed instructions.

The input of this step is a structured response message from server containing evaluation and program data.

The output of this step is a visual and interactive representation of risk indices, recommendations, and schedules on the terminal's user interface, enabling the user to review and select actions.

### Step 14:

User executes recommended activities and provides feedback.

User reads the displayed information, follows instructions such as performing exercise, changing diet, completing cognitive tasks, and attending scheduled events, and then reports completion or issues via the terminal interface. User may also provide new audio or text statements describing changes in condition or concerns.

The input of this step is the guidance shown by the terminal in Step 13 and the user's own current state.

The output of this step is new behavior information, health-related observations, and additional audio or text inputs entered at the terminal and stored locally for later transmission to server.

### Step 15:

Terminal transmits updated behavior, health, emotion, and expenditure information to the server.

Terminal collects task completion flags, updated activity measurements (for example, steps, exercise duration), any newly recorded mood or emotion ratings, and optionally newly recorded expenditure data. Terminal packages these into an updated data message and transmits the message via encrypted communication to server.

The input of this step is the locally stored execution results and new user entries from Step 14.

The output of this step is a refreshed set of behavior information, health information, emotion information, and expenditure information received by server and stored in the databases, which server uses as new input for subsequent iterations of Steps 4 through 11.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

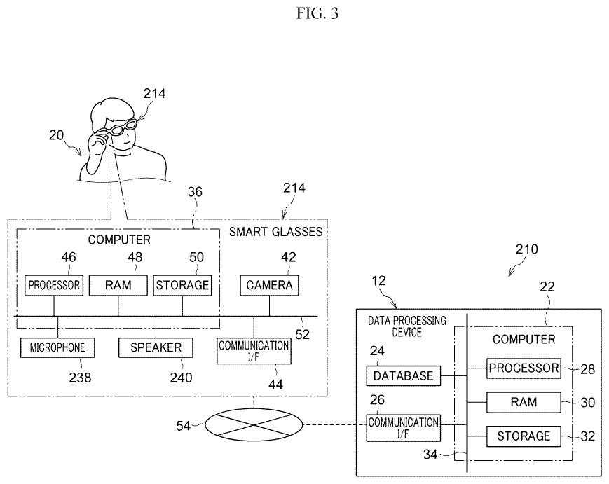

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

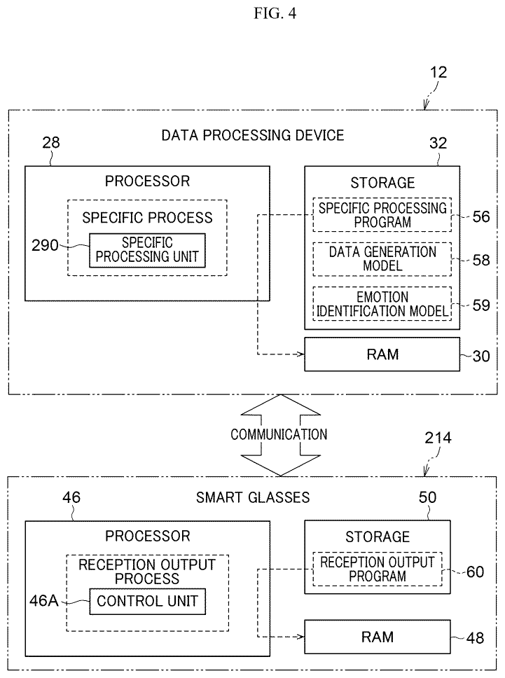

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. naïve Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

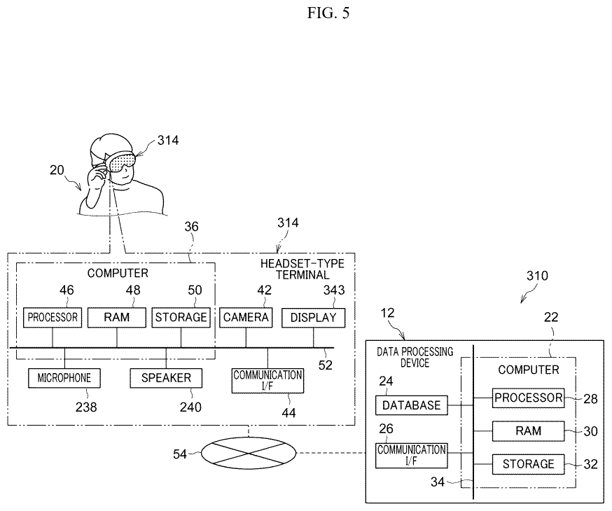

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

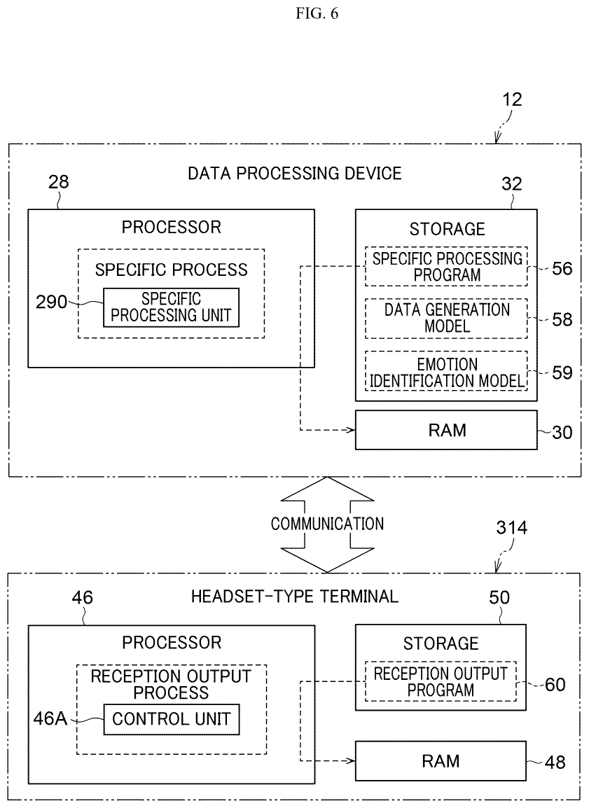

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

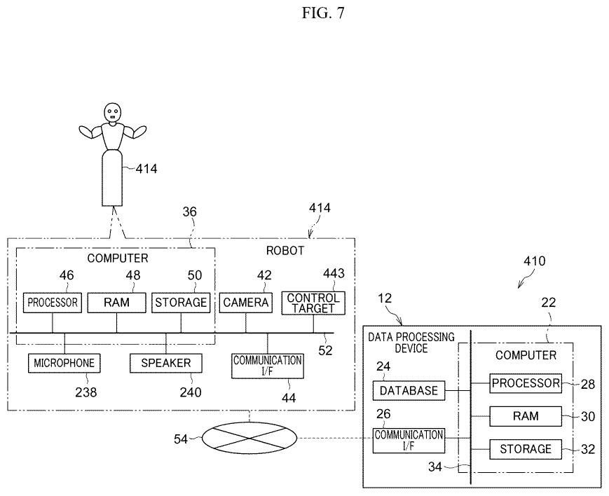

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

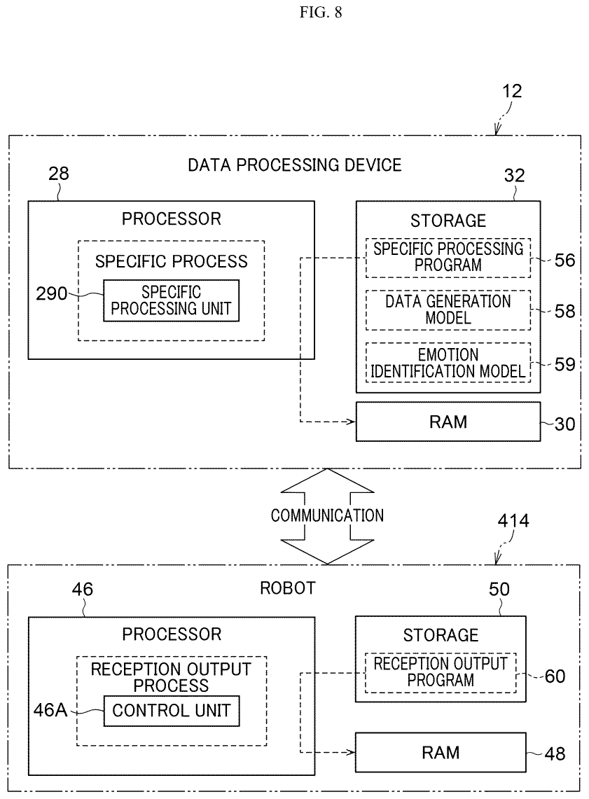

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

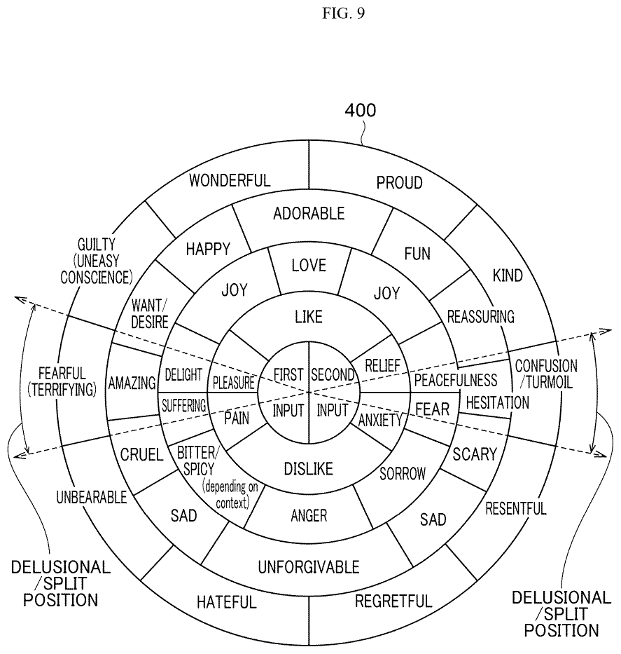

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https: //ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

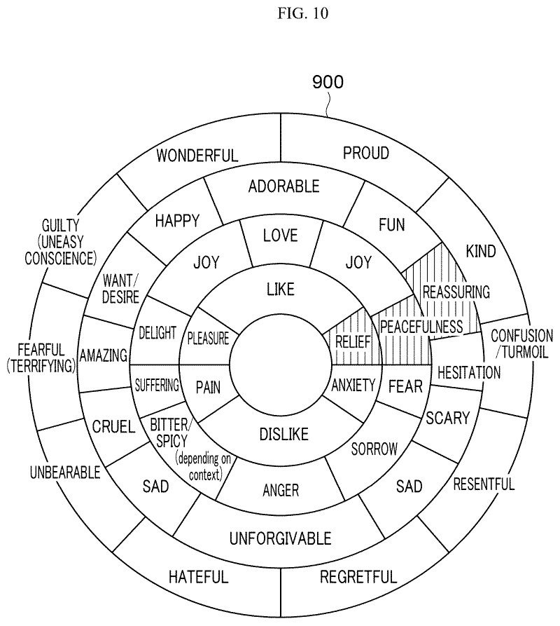

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure.

Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire input information including voice information or character information and perform processing to convert the voice information into character information,
generate, on the basis of the character information and user-related information, a prompt sentence including evaluation items and an output format relating to a risk of cognitive function decline, and generate input data by combining the prompt sentence with the character information,
input the input data to a generative artificial intelligence model, obtain analysis result data by extracting risk patterns from the character information by natural language processing, classifying the risk patterns, and calculating a risk level,
store the analysis result data in a storage device in association with time-series information, and generate transition information of the risk level for each user,
generate output information including an explanatory sentence for the user and action recommendation information on the basis of the analysis result data and the transition information of the risk level, and
transmit the output information to a terminal device via a communication network.

### (Supplementary 2)

The system according to supplementary 1,
wherein the processor is configured to
include, in the output information, instruction information that prompts consultation with a specialized institution when the risk level is equal to or higher than a predetermined threshold, and lifestyle improvement information associated with the risk patterns, and cause the output information to be presented visually or audibly by the terminal device.

### (Supplementary 3)

The system according to supplementary 1,
wherein the processor is configured to
acquire additional information including behavior information and biological information of the user, generate additional-information summary data by summarizing the additional information, incorporate the additional-information summary data into the prompt sentence so as to instruct the generative artificial intelligence model to perform risk evaluation based on the character information and the additional information, and output the risk patterns and the risk level.

### Application Example 1

### (Supplementary 1)

A system comprising a processor,
wherein the processor is configured to
receive audio data from a terminal device that acquires voice information of a user, and
convert the audio data into character information by using a speech recognition unit,
perform, on the character information, language processing including word segmentation,
part-of-speech tagging, semantic analysis, and keyword extraction by using a language processing unit, and generate feature information including expressions relating to memory,
actions, and time of the user as an information extraction unit,
construct, on the basis of the feature information and the character information, a prompt sentence to be input to a generative artificial intelligence model, and define, in the prompt sentence, an output format for risk evaluation and output conditions for explanatory information as a prompt generation unit,
input the prompt sentence to the generative artificial intelligence model, obtain from the generative artificial intelligence model an analysis result including a risk level relating to the user and a reason explanation, calculate a numerical risk index on the basis of the analysis result, and specify a risk pattern by comparing the numerical risk index with a predetermined threshold as a risk evaluation unit,
store the risk index and the analysis result as record information, and detect a long-term change trend by calculating a transition of a plurality of risk indices at different times as a history management unit,
when the risk pattern or the change trend satisfies a predetermined condition, generate and transmit notification information to an information display device for store staff, and output guidance information relating to a response policy to the user as a notification unit, and
generate, by using the generative artificial intelligence model, a question sentence for additional input in accordance with the analysis result and the change trend, and control a dialogue by transmitting the question sentence to the terminal device as a dialogue control unit.

### (Supplementary 2)

The system according to supplementary 1,
wherein the processor is configured to,
when the risk pattern indicates a high risk, output control information for causing the information display device for store staff to display guidance information including a recommendation that the user consult a medical institution.

### (Supplementary 3)

The system according to supplementary 1,
wherein the processor is configured to store behavior information and health-related information of the user in a time series as the history management unit, and incorporate history information including the behavior information and the health-related information into the prompt sentence generated by the prompt generation unit, thereby causing the generative artificial intelligence model to perform risk evaluation in consideration of a long-term state change.

### Example 2

### (Supplementary 1)

A system comprising a processor,
wherein the processor is configured to
process input information using an information processing unit to convert voice information into character information,
aggregate the character information and lifestyle information, behavior information, and health information and generate a prompt sentence to be input to a generative AI model, cause the generative AI model to execute natural language processing using the prompt sentence, and identify a risk pattern and an analysis result relating to cognitive function decline based on the character information and the lifestyle information, behavior information, and health information,
manage an information storage unit that stores the lifestyle information, behavior information, and health information, and perform numerical computation by a machine learning model using the lifestyle information, behavior information, and health information acquired from the information storage unit to calculate a risk index relating to cognitive function decline,
select task information for maintaining cognitive function based on the risk index and the analysis result by the generative AI model, and generate brain function training program information including difficulty information,
transmit the brain function training program information and the analysis result as output information to a terminal device, acquire an execution result of the task information from the terminal device, record the execution result in the information storage unit, and update the difficulty information according to the execution result, and
generate a prompt sentence for generating a response sentence including an explanation and an action guideline for a user based on the risk index, the analysis result, and the task information, and cause the generative AI model to generate the response sentence by inputting the prompt sentence to the generative AI model.

### (Supplementary 2)

The system according to supplementary 1,
wherein the processor is configured to
transmit, to the terminal device, an instruction information that prompts consultation with a medical service provider when the risk index satisfies a predetermined condition, and present, to the user, a warning relating to cognitive function decline and a proposal for improvement of lifestyle habits based on the response sentence and the risk index.

### (Supplementary 3)

The system according to supplementary 1,
wherein the processor is configured to
execute an acquisition process for continuously acquiring the behavior information and the health information of the user, generate a time-series analysis prompt sentence using the behavior information and the health information obtained by the acquisition process at a plurality of time points, and cause the generative AI model to evaluate a progression degree and a future risk of cognitive function decline by inputting the time-series analysis prompt sentence to the generative AI model.

### Application Example 2

### (Supplementary 1)

A system comprising a processor,
wherein the processor is configured to
process audio information to generate character information by using a sound recognition unit that converts the audio information into the character information,
generate a prompt sentence to be input to a generative artificial intelligence model based on at least part of the character information and at least part of one or more of behavior information, health information, emotion information, and expenditure information, and input the prompt sentence together with the character information and the one or more kinds of information to the generative artificial intelligence model,
analyze, by using the generative artificial intelligence model, the character information and the one or more kinds of information included in the prompt sentence, identify a risk pattern related to cognitive decline and an emotional state, and generate evaluation information including a risk index and recommended actions based on an analysis result,
select or generate, based on the evaluation information, a prevention program including at least one of exercise, dietary management, and cognitive function training, and a support program corresponding to the emotional state, and provide the prevention program and the support program to a user information processing apparatus,
manage reservation information and participation status regarding activities or service usage in a physical space that are related to the prevention program and the support program, and store results of execution of the activities or the services as at least part of the behavior information or the health information, and
transmit and receive the behavior information, the health information, the emotion information, and the expenditure information between the system and the user information processing apparatus by using encrypted communication, and secure information safety by the encrypted communication.

### (Supplementary 2)

The system according to supplementary 1,
wherein the processor is configured to
generate instruction information that recommends consultation with a medical institution or a specialist based on the evaluation information, and present the instruction information to the user information processing apparatus.

### (Supplementary 3)

The system according to supplementary 1,
wherein the processor is configured to generate a prompt sentence to be input to the generative artificial intelligence model based on a correlation between a time-series change of the behavior information and the health information and at least one of the emotion information and the expenditure information, input the prompt sentence to the generative artificial intelligence model to calculate a risk score obtained by quantifying a risk of cognitive decline, and generate advice information relating to expenditure suppression or expenditure review according to the risk score.

What is claimed is:

1. A system comprising:
a communication interface coupled to a packet-switched network; and
circuitry configured to:
acquire input information comprising voice information from a terminal device via the communication interface, and convert the voice information into character information by executing a speech recognition process;
generate, based on the character information and user-related information stored in a storage device, a prompt comprising evaluation items and an output format specification for risk-level assessment, and generate input data by combining the prompt with the character information;
input the input data to a generative neural network model and obtain analysis result data by extracting risk patterns by natural language processing, classifying the risk patterns, and calculating a risk level;
store the analysis result data in the storage device in association with time-series information and generate transition information of the risk level; and
generate output information comprising an explanatory sentence and action recommendation information based on the analysis result data and the transition information, and transmit the output information to the terminal device via the packet-switched network.

2. The system according to claim 1, wherein the speech recognition process comprises converting the voice information into a sequence of phoneme representations, applying a language model to decode the phoneme representations into word sequences, and generating timestamped text segments.

3. The system according to claim 2, wherein the circuitry is further configured to extract acoustic features from the voice information comprising at least pitch contour, speaking rate, pause duration, and energy variation, and to store the acoustic features in the storage device in association with the character information.

4. The system according to claim 3, wherein the prompt further comprises the acoustic features as numerical parameters, and wherein the evaluation items comprise linguistic complexity metrics, vocabulary diversity indicators, and temporal coherence measures derived from the character information.

5. The system according to claim 4, wherein the circuitry is further configured to parse the analysis result data to extract structured fields comprising a risk category label, a numerical risk score, a confidence value, and a list of identified risk pattern descriptors.

6. The system according to claim 5, wherein the risk patterns comprise at least one of word retrieval difficulty patterns, repetition patterns, syntactic simplification patterns, and topic drift patterns detected by the generative neural network model based on the prompt.

7. The system according to claim 1, wherein the circuitry is further configured to acquire behavior data and sensor data from the terminal device, the behavior data comprising interaction frequency, response latency, and session duration, and to generate a supplementary prompt that includes the behavior data and the sensor data for supplementary risk-level evaluation.

8. The system according to claim 7, wherein the supplementary prompt instructs the generative neural network model to evaluate the risk level based on a combination of the character information, the acoustic features, and the behavior data, and wherein the circuitry aggregates the analysis result data from the primary prompt and the supplementary prompt to compute a composite risk level.

9. The system according to claim 8, wherein the composite risk level is calculated as a weighted combination of component risk scores, the weights being stored in the storage device and adjustable based on historical analysis results.

10. The system according to claim 1, wherein the time-series information comprises timestamps, session identifiers, and sequential risk level values, and wherein the transition information comprises at least a trend direction indicator, a rate of change metric, and a comparison of the current risk level with a historical baseline.

11. The system according to claim 10, wherein the circuitry is further configured to detect an anomalous transition in the risk level by comparing the rate of change metric with a threshold, and to generate an alert notification for transmission to the terminal device when the threshold is exceeded.

12. The system according to claim 11, wherein the alert notification comprises the risk level, the trend direction indicator, and a recommendation to take a specified action, and wherein the circuitry transmits the alert notification to at least one additional terminal device associated with a related party via the packet-switched network.

13. The system according to claim 1, wherein the circuitry is further configured to receive feedback information from the terminal device indicating the user's response to the action recommendation, and to update prompt-generation parameters stored in the storage device based on the feedback information.

14. The system according to claim 13, wherein the update comprises adjusting evaluation item weights, modifying the output format specification, and incorporating feedback-derived context into subsequent prompts.

15. The system according to claim 1, wherein the circuitry is further configured to maintain a longitudinal record comprising a plurality of analysis result data entries associated with the same user identifier, and to generate a summary report comprising statistical measures of risk level progression over a measurement period.

16. The system according to claim 1, wherein the risk-level assessment relates to cognitive function evaluation, the risk patterns comprise linguistic indicators associated with cognitive decline, and the action recommendation information comprises guidance for consulting a specialized facility.

17. The system according to claim 16, wherein the circuitry is further configured to calculate a closed-loop assessment accuracy metric based on a ratio of confirmed risk assessments to total assessments over a measurement period, and to adjust generation parameters of the generative neural network model when the metric falls below a threshold.

18. A system comprising:
a communication interface coupled to a packet-switched network; and
circuitry configured to:
acquire voice information from a terminal device via the communication interface, convert the voice information into character information by speech recognition, and extract acoustic features comprising pitch contour, speaking rate, pause duration, and energy variation;
generate a prompt comprising the character information, the acoustic features as numerical parameters, evaluation items including linguistic complexity metrics and vocabulary diversity indicators, and an output format specification, and input the prompt to a generative neural network model to obtain analysis result data comprising a risk category label, a numerical risk score, a confidence value, and risk pattern descriptors;
acquire behavior data from the terminal device comprising interaction frequency, response latency, and session duration, generate a supplementary prompt including the behavior data, and compute a composite risk level by weighted aggregation of component risk scores;
store the analysis result data and the composite risk level in a storage device with time-series information, generate transition information comprising trend direction, rate of change, and historical baseline comparison, and detect anomalous transitions by threshold comparison;
generate output information comprising an explanatory sentence and action recommendation based on the analysis result data and the transition information, and transmit the output information and any alert notifications to the terminal device and to additional terminal devices via the packet-switched network; and
receive feedback information from the terminal device and update prompt-generation parameters based on the feedback.

19. The system according to claim 18, wherein the circuitry is further configured to maintain a longitudinal record of analysis result data associated with a user identifier and to generate a summary report comprising statistical measures of risk level progression over a measurement period.

20. A method comprising:
acquiring, by circuitry coupled to a packet-switched network, voice information from a terminal device and converting the voice information into character information by speech recognition;
generating a prompt comprising the character information, evaluation items, and an output format specification for risk-level assessment, and inputting the prompt to a generative neural network model to obtain analysis result data by extracting and classifying risk patterns;
storing the analysis result data in a storage device with time-series information and generating transition information of the risk level;
generating output information comprising an explanatory sentence and action recommendation based on the analysis result data and the transition information; and
transmitting the output information to the terminal device via the packet-switched network.
